(19) United States
(12) Patent Application Publication
(10) Pub. No.: US 2024/0332551 A1
(43) Pub. Date: Oct. 3, 2024

(54) COMPOSITE AND MEMBRANE ELECTRODE ASSEMBLY INCLUDING ACTIVE METAL PARTICLES AND SACRIFICIAL METAL PARTICLES, AND FUEL CELL INCLUDING THE SAME

(71) Applicant: DAEGU GYEONGBUK INSTITUTE OF SCIENCE AND TECHNOLOGY, Daegu (KR)

(72) Inventors: Jong-Sung YU, Seoul (KR); Cheol Hwan SHIN, Gangwon-do (KR)

(73) Assignee: DAEGU GYEONGBUK INSTITUTE OF SCIENCE AND TECHNOLOGY, Daegu (KR)

(21) Appl. No.: 18/619,506

(22) Filed: Mar. 28, 2024

(30) Foreign Application Priority Data
Mar. 30, 2023 (KR) 10-2023-0041717
Apr. 28, 2023 (KR) 10-2023-0056068

(51) Int. Cl. H01M 4/86; H01M 4/92; H01M 8/1004

(52) U.S. Cl. CPC H01M 4/8663; H01M 4/8605; H01M 4/926; H01M 8/1004

(57) ABSTRACT

Provided are a composite and a membrane electrode assembly including active metal particles and sacrificial metal particles, and a fuel cell including the same. The composite according to the present invention includes active metal particles and sacrificial metal particles independently supported on a carbon support, it can suppress the deterioration of the active metal and have significantly improved durability while maintaining excellent activity of the catalyst. The membrane electrode assembly according to the present invention can have excellent catalytic activity and significantly improved durability for the same reasons as the above-described composite.

### CROSS-REFERENCE TO RELATED APPLICATIONS

This application claims priority under 35 U.S.C. § 119 to Korean Patent Application No. 10-2023-0041717, filed on Mar. 30, 2023, and Korean Patent Application No. 10-2023-0056068, filed Apr. 28, 2023, in the Korean Intellectual Property Office, the disclosure of which is incorporated herein by reference in its entirety.

### TECHNICAL FIELD

The following disclosure relates to a composite and a membrane electrode assembly including active metal particles and sacrificial metal particles, and a fuel cell including the same.

### BACKGROUND

A fuel cell is an electrochemical device which converts chemical energy generated by oxidation/reduction of fuel into electrical energy, and is being spotlighted as an eco-friendly energy source.

An electrode reaction in the fuel cell includes a hydrogen oxidation reaction (HOR) in an anode and an oxygen reduction reaction (ORR) in a cathode, and a catalyst is essentially used for improving efficiency of the electrochemical reaction. In particular, since the oxygen reduction reaction in a cathode is slower than the hydrogen oxidation reaction in an anode and the reaction rate determines performance of the entire fuel cell, noble metal catalysts such as platinum (Pt), palladium (Pd), and gold (Au) are currently mainly used for promoting the oxygen reduction reaction in a cathode.

As an example, Korean Patent Laid-Open Publication No. 10-1484188 discloses a catalyst including platinum supported on a carbon support, and the catalyst was intended to increase catalytic activity while decreasing noble metal usage by increasing an active surface area, but constant consumption and inefficiency of a high-priced platinum catalyst are increased due to occurrence of degradation of supported platinum nanoparticles, thereby deteriorating catalytic activity and durability. Specifically, the degradation of platinum nanoparticles as such occurs by occurrence of an oxidation reduction reaction in an anode and a side reaction such as a platinum oxidation reaction in a cathode as air enters the anode. In particular, oxidized platinum (Pt) particles do not perform the oxidation reduction reaction well and may cause dissolution of platinum and Ostwalt ripening. This induces aggregation or a growth in size of platinum (Pt) particles and decreases utilization efficiency of a platinum catalyst, resulting in the degradation of platinum (Pt) particles to deteriorate performance of a fuel cell.

As a method for suppressing the degradation as such, a study of coating a surface of an active metal particle such as platinum (Pt), palladium (Pd), and gold (Au) with carbon or a metal oxide is actively progressing. However, the coating method as such decreases the active site of the active metal and poisons the catalyst due to occurrence of unnecessary by-products such as hydrogen peroxide due to a two-electron reaction, thereby decreasing activity and stability of a fuel cell. In addition, the manufacturing process is complicated by the characteristics of the catalyst such as morphology and surface energy.

Therefore, there is a need to solve the degradation problem of active metal more fundamentally in order to provide a fuel cell having significantly improved durability while maintaining activity of noble metal-based catalyst.

### RELATED ART DOCUMENTS

### Patent Document

Korean Patent Laid-Open Publication No. 10-1484188

### Non-Patent Document

Chem. Mater. 2017, 29, 21, 9579-9587 (Oct. 17, 2017)

### SUMMARY

An embodiment of the present invention is directed to providing a composite and a membrane electrode assembly which have excellent catalytic activity and significantly improved durability.

Another embodiment of the present invention is directed to providing an electrode for a fuel cell including the composite of the present invention.

Another embodiment of the present invention is directed to providing a fuel cell including the electrode for a fuel cell and/or a membrane electrode assembly.

Still another embodiment of the present invention is directed to providing a method for manufacturing the composite and the membrane electrode assembly.

In one general aspect, a composite includes: a carbon support; active metal particles; and sacrificial metal particles which are oxidized or reduced instead of the active metal particles, wherein the active metal particles and the sacrificial metal particles are independently supported on the carbon support.

In the composite according to the present invention, the active metal particles and the sacrificial metal particles may not form an alloy with each other.

In the composite according to the present invention, the active metal particles may include one or more metals selected from the group consisting of palladium (Pd); platinum (Pt); gold (Au); ruthenium (Ru); rhodium (Rh); iridium (Ir); osmium (Os); and alloys including the metals.

In the composite according to the present invention, a metal included in the sacrificial metal particles may have a lower standard reduction potential than a metal included in the active metal particles.

In the composite according to the present invention, the sacrificial metal particles may include one or more metals selected from the group consisting of silver (Ag); palladium (Pd); iridium (Ir); ruthenium (Ru); rhodium (Rh); platinum (Pt); osmium (Os); iron (Fe); aluminum (Al); and alloys including the metals.

In the composite according to the present invention, a ratio (D₂/D₁) between an average particle diameter (D₂) of the active metal particles after an accelerated durability test of 30,000 cycles of the composite and an average particle diameter (D₁) of the active metal particles before the accelerated durability test may be 3 or less.

In the composite according to the present invention, an atomic ratio between a sacrificial metal included in the sacrificial metal particles and an active metal included in the active metal particles may be 1:0.1 to 1:50.

In the composite according to the present invention, the active metal included in the active metal particles may include platinum (Pt), and a difference in 2θ values of maximum peaks shown in a range of 2θ=39.8±1.0° in X-ray diffraction (XRD) spectra of the composite and pure platinum (Pt) may be 0.3° or less.

In the composite according to the present invention, the active metal included in the active metal particles may include platinum (Pt), and the composite may have a ratio (I₀/I_{II}) between a Pt (0) peak intensity (I₀) and a Pt(II) peak intensity (I_{II}) in a Pt 4f_{7/2} XPS spectrum by X-ray photoelectron spectroscopy (XPS) of 1.8 or more.

In another general aspect, a method for manufacturing a composite includes: mixing a dispersion including a carbon support on which active metal particles are supported and a solution including a sacrificial metal precursor to prepare a first reaction solution; and adding a reducing agent to the first reaction solution to synthesize a composite in which the active metal particles and sacrificial metal particles are independently supported on the carbon support.

In another general aspect, another method for manufacturing a composite includes: mixing a dispersion including a carbon support on which active metal particles are supported and a dispersion including a carbon support on which sacrificial metal particles are supported to prepare a second reaction solution; and adding a reducing agent to the second reaction solution to synthesize a composite in which the active metal particles and the sacrificial metal particles are independently supported on the carbon support.

In another general aspect, a membrane electrode assembly includes: a cathode including a first catalyst layer and a first gas diffusion layer; an anode including a second catalyst layer and a second gas diffusion layer; and a polymer electrolyte membrane disposed between the cathode and the anode, wherein the first catalyst layer includes active metal particles, and the first gas diffusion layer includes a support for the first gas diffusion layer; and sacrificial metal particles which are supported on the support for the first gas diffusion layer and are oxidized or reduced instead of the active metal particles.

In the membrane electrode assembly according to the present invention, one surface of the support for the first gas diffusion layer on which the sacrificial metal particles are placed may face one surface of the first catalyst layer.

In the membrane electrode assembly according to the present invention, the second catalyst layer may include the active metal particles, and the second gas diffusion layer may include a support for the second gas diffusion layer and the sacrificial metal particles which are supported on the support for the second gas diffusion layer and are oxidized or reduced instead of the active metal particles.

In the membrane electrode assembly according to the present invention, the active metal particles may include one or more metals selected from the group consisting of palladium (Pd); platinum (Pt); gold (Au); ruthenium (Ru); rhodium (Rh); iridium (Ir); osmium (Os); and alloys including the metals.

In the membrane electrode assembly according to the present invention, a metal included in the sacrificial metal particles may have a lower standard reduction potential than a metal included in the active metal particles.

In the membrane electrode assembly according to the present invention, the sacrificial metal particles may include one or more metals selected from the group consisting of silver (Ag); palladium (Pd); iridium (Ir); ruthenium (Ru); rhodium (Rh); platinum (Pt); osmium (Os); iron (Fe); aluminum (Al); and alloys including the metals.

In the membrane electrode assembly according to the present invention, a ratio (D₂/D₁) between an average particle diameter (D₂) of the active metal particles after an accelerated durability test of 30,000 cycles and an average particle diameter (D₁) of the active metal particles before the accelerated durability test may be 3 or less.

In the membrane electrode assembly according to the present invention, an atomic ratio between the sacrificial metal included in the sacrificial metal particle included in the first gas diffusion layer and the active metal included in the active metal particles included in the first gas diffusion layer may be 0.1:1 to 100:1.

In the membrane electrode assembly according to the present invention, the active metal included in the active metal particles may include platinum (Pt), and the first catalyst layer may have a ratio (I₂/I₁) between a Pt(II) peak intensity (I₂) after an accelerated durability test of 90,000 cycles and a Pt(II) peak intensity (I₁) before the accelerated durability test in a Pt 4f XPS spectrum by X-ray photoelectron spectroscopy (XPS) of 0.5 or more.

In the membrane electrode assembly according to the present invention, a content of the sacrificial metal particles per unit area of the support for the first gas diffusion layer may be 0.1 to 100 mg/cm².

In another general aspect, a method for manufacturing a membrane electrode assembly includes: 1) doping a sacrificial metal precursor on a support for a first gas diffusion layer; 2) reducing the sacrificial metal precursor doped on the support for a first gas diffusion layer to prepare a first gas diffusion layer in which sacrificial metal particles are supported on the support for a first gas diffusion layer; 3) forming a first catalyst layer on one surface of a polymer electrolyte membrane; 4) forming a second catalyst layer on the other surface of the polymer electrolyte membrane; 5) forming the first gas diffusion layer on the first catalyst layer; and 6) forming a second gas diffusion layer on the second catalyst layer.

In another general aspect, an electrode for a fuel cell includes the composite described above.

In still another general aspect, a fuel cell includes: the membrane electrode assembly described above or the electrode for a fuel cell.

Other features and aspects will be apparent from the following detailed description, the drawings, and the claims.

### BRIEF DESCRIPTION OF THE DRAWINGS

FIG. 1 is a schematic diagram for describing an effect of whether silver (Ag) particles are included on ORR catalytic activity.

FIGS. 2 and 3 are schematic diagrams of a method for manufacturing a composite according to an exemplary embodiment.

FIG. 4 is a drawing showing XRD patterns of Comparative Example 1 and Examples 1 to 3.

FIG. 5 is a drawing showing XRD patterns of Comparative Examples 1 and 2 and Example 2.

FIG. 6 is a drawing showing Pt 4f XPS spectra of Comparative Example 1 and Examples 1 to 3.

FIG. 7 is a drawing showing Ag 3d XPS spectra of Comparative Example 1 and Examples 1 to 3.

FIG. 8 is a drawing showing Pt 4f XPS spectra of Comparative Examples 1 and 2 and Example 2.

FIG. 9 is a drawing showing Ag 3d XPS spectra of Comparative Examples 2 and 3 and Example 2.

FIG. 10 is HAADF-STEM images of Example 2 and a corresponding EDS mapping image, and FIG. 11 is enlarged images thereof.

FIG. 12 is HAADF-STEM images of Comparative Example 2 and a corresponding EDS mapping image.

FIG. 13 is drawings showing results of evaluating electrochemical performance of Comparative Example 1 and Examples 1 to 3.

FIG. 14 is drawings showing CV curves before and after ADT of each of Comparative Example 1 and Examples 1 to 3.

FIG. 15 is transmission electron microscope (TEM, FEI Tecnai G2 twin) images before and after ADT of each of Comparative Example 1 and Example 2.

FIG. 16 is drawings showing results of evaluating electrochemical performance of Comparative Example 2 in an alloy form.

FIGS. 17 and 18 are drawings showing performance before and after ADT performed for 30 k cycles of a fuel cell to which each of Comparative Example 1 and Examples 1 to 3 was applied as a cathode catalyst.

FIG. 19 is a drawing showing polarization curves and power density curves before and after ADT of a fuel cell to which Comparative Example 2 in an alloy form was applied as a cathode catalyst.

FIG. 20 is drawings showing a change in size of particles before and after ADT in fuel cells of Comparative Example 1 and Example 2.

FIGS. 21 to 23 are drawings showing results of an on-line ICP-MS experiment performed for Comparative Example 1 and Example 2.

FIGS. 24 to 26 are drawings showing results of an on-line ICP-MS experiment performed in the same manner for Comparative Examples 1 and 2.

FIG. 27 is drawings showing Ex-situ XAS spectra of Pt L₃-edges (or Ag K-edges) for Comparative Example 1 (or Comparative Example 3), Comparative Example 2, Example 2, Pt foil (or Ag foil), and PtO₂ (or AgO₂).

FIG. 28 is drawings showing In-situ XAS spectra of Pt L₃-edges for Comparative Example 1, Example 2, and Comparative Example 2.

FIG. 29 is drawings showing a platinum oxidation states depending on applied potentials of Comparative Example 1, Example 2, and Comparative Example 2, which were calculated by the results according to FIG. 28.

FIG. 30 is a drawing showing a schematic diagram of a membrane electrode assembly according to an exemplary embodiment.

FIG. 31 is a drawing showing an operation principle of a fuel cell depending on inclusion of sacrificial metal particles.

FIG. 32 is a drawing showing a schematic diagram of a process of manufacturing a first gas diffusion layer in which the sacrificial metal particles are supported on a support for the first gas diffusion layer.

FIG. 33 is drawing showing scanning electron microscope (SEM) images of gas diffusion layers of Comparative Example 4 and Example 4.

FIG. 34 is drawings showing an SEM image of the gas diffusion layer of Comparative Example 4 and a corresponding energy dispersive X-ray spectroscopy (EDS) mapping image, and FIG. 35 is drawings showing an SEM image of the gas diffusion layer of Example 4 and a corresponding EDS mapping image.

In FIG. 36, (a) is a drawing showing X-ray diffraction (XRD) patterns of the gas diffusion layers of Comparative Example 4 and Example 4, and (b) is a drawing showing Ag 3d X-ray photoelectron spectroscopy (XPS) spectra of the gas diffusion layers of Comparative Example 4 and Example 4.

FIG. 37 is showing polarization curves depending on an accelerated durability test (ADT) cycles of fuel cells to which Example 5 and Comparative Example 5 were applied.

FIG. 38 is drawings showing results of electrochemical Impedance Spectroscopy (EIS) measurement depending on ADT cycles of fuel cells to which Example 5 and Comparative Example 5 were applied.

FIG. 39 is drawings showing cyclic Voltammetry (CV) curves depending on ADT cycles of fuel cells to which Example 5 and Comparative Example 5 were applied.

FIG. 40 is a drawing showing Pt 4f XPS spectra, measured before and after performing ADT for cathode catalyst layers included in membrane electrode assemblies manufactured in Comparative Example 5 and Example 5.

In FIG. 41, (a) is a drawing showing XRD patterns depending on ADT cycles of a gas diffusion layer included in the membrane electrode assembly manufactured in Example 5, and (b) is a drawing showing Ag 3d XPS spectra.

FIG. 42 is drawings showing transmission electron microscope (TEM) images of catalyst layers included in Comparative Example 5 and Example 5 depending on ADT cycles.

FIG. 43 is drawings showing a high angle annular dark field scanning transmission electron microscopy (HAADF-STEM) image of a catalyst layer included in Example 5 after 90,000 (90 k) cycles, and corresponding EDS mapping image and EDS spectrum.

FIG. 44 is a drawing showing Ag 3d XPS spectra depending on ADT cycles of the catalyst layer of Example 5.

### DETAILED DESCRIPTION OF MAIN ELEMENTS

10: first gas diffusion layer
20: first catalyst layer
30: polymer electrolyte membrane
1: support for first gas diffusion layer
2: sacrificial metal particle

### DETAILED DESCRIPTION OF EMBODIMENTS

The embodiments described in the present specification may be modified in many different forms, and the technology according to an exemplary embodiment is not limited to the embodiments set forth herein. In addition, the embodiments of an exemplary embodiment are provided so that the present disclosure will be described in more detail to a person with ordinary skill in the art. Technical terms and scientific terms used herein have the general meaning commonly understood by a person skilled in the art to which the present invention pertains unless otherwise defined, and description for the known function and configuration which may unnecessarily obscure the gist of the present invention will be omitted in the following description and the accompanying drawings.

The embodiments described in the present specification may be modified in many different forms, and the technology according to an exemplary embodiment is not limited to the embodiments set forth herein. In addition, the embodiments of an exemplary embodiment are provided so that the present disclosure will be described in more detail to a person with ordinary skill in the art.

In addition, the singular form used in the specification and claims appended thereto may be intended to include a plural form also, unless otherwise indicated in the context.

In addition, in the present specification and the appended claims, the terms such as “comprise” or “have” mean that there is a characteristic or a constituent element described in the specification, and as long as it is not particularly limited, a possibility of adding one or more other characteristics or constituent elements is not excluded in advance.

In addition, the numerical range used in the present specification includes all values within the range including the lower limit and the upper limit, increments logically derived in a form and span of a defined range, all double limited values, and all possible combinations of the upper limit and the lower limit in the numerical range defined in different forms.

In addition, unless otherwise particularly defined in the specification of the present invention, values which may be outside a numerical range due to experimental error rounding off of a value are also included in the defined numerical range.

In addition, the terms “about”, “substantially”, and the like used in the present specification and the appended claims are used in the meaning of the numerical value or in the meaning close to the numerical value when unique manufacture and material allowable errors are suggested in the mentioned meaning, and are used for preventing the disclosure mentioning a correct or absolute numerical value for better understanding of the present specification and the attached claims from being unfairly used by an unconscionable infringer.

In addition, throughout the specification, unless explicitly described to the contrary, “comprising” any constituent elements will be understood to imply further inclusion of other constituent elements rather than exclusion of other constituent elements.

In addition, in the present specification, it will be understood that when an element such as a layer, film, region, or substrate is referred to as being “on” or “above” another element, it can be directly on the other element or intervening elements may also be present.

In addition, the terms such as “first” and “second” used in the present specification may be used to describe various constituent elements, but the constituent elements are not to be limited to the terms. The terms are only used to differentiate one constituent element from other constituent elements.

Hereinafter, a composite, a method for manufacturing a composite, a membrane electrode assembly, a method for manufacturing a membrane electrode assembly, an electrode, and different fuel cells will be described in detail.

The present invention provides a composite, and the composite includes: a carbon support; active metal particles; and sacrificial metal particles which are oxidized or reduced instead of the active metal particles, wherein the active metal particles and the sacrificial metal particles are independently supported on the carbon support.

According to an exemplary embodiment, the description that the active metal particles and the sacrificial metal particles are independently supported on the carbon support means that the active metal particles and the sacrificial metal particles are physically spaced apart.

Since the composite according to the present invention includes active metal particles and sacrificial metal particles which are independently supported on a carbon support, degradation of the active metals may be effectively suppressed, thereby having significantly improved durability as compared with conventional noble metal-based catalysts while maintaining excellent catalytic activity.

Specifically, since the composite according to the present invention includes the sacrificial metal particles which are oxidized before the active metal particles, oxidation of the active metal may be effectively suppressed, thereby solving a degradation problem of the active metal particles, which is a cause of deterioration of catalytic activity and durability. Besides, since the sacrificial metal particles and the active metal particles independently exist, the sacrificial metal particles do not cover the catalytic active site of the active metal included in the active metal particles, thereby maintaining excellent catalytic activity of a pure active metal catalyst.

According to an exemplary embodiment, the active metal particles and the sacrificial metal particles may not form an alloy with each other. The meaning of the active metal particles and the sacrificial metal particles being independently supported may even include the case in which the active metal included in the active metal particles and the sacrificial metal included in the sacrificial metal particles do not form an alloy and are not chemically bonded, even when the active metal particles and the sacrificial metal particle are physically in contact with each other. When the active metal particles and the sacrificial metal particles form an alloy with each other, the sacrificial metal particles may cover the catalytic active site of the active metal particles to deteriorate catalytic activity. However, when the active metal particles and the sacrificial metal particles independently exist without forming an alloy with each other, the sacrificial metal particles may not cover the catalytic activity site of the active metal included in the active metal particles, so that catalytic activity may be excellent.

According to an exemplary embodiment, a metal included in the sacrificial metal particles, that is, a sacrificial metal, may have a lower standard reduction potential than a metal included in the active metal particles, that is, an active metal. The active metal included in the active metal particles may be any metal which has a higher standard reduction potential than the sacrificial metal included in the sacrificial metal particles while having catalytic activity.

According to an exemplary embodiment, the standard reduction potential of the active metal included in the active metal particles may be 0.7 V or more, 0.8 V or more, 0.9 V or more, or 1.0 V or more and as an upper limit, 3.0 V or less, 2.5 V or less, 2.0 V or less, or 1.5 V or less. Specifically, the standard reduction potential of the active metal included in the active metal particles may be 0.7 to 3.0 V, 0.8 to 2.5 V, 0.9 to 2.0 V, or 1.0 to 1.5 V.

According to an exemplary embodiment, the standard reduction potential of the sacrificial metal included in the sacrificial metal particles may be 0.3 V or more, 0.4 V or more, 0.5 V or more, or 0.6 V or more and as an upper limit, 1.1 V or less, 1.0 V or less, 0.9 V or less, or 0.8 V or less. Specifically, the standard reduction potential of the sacrificial metal included in the sacrificial metal particles may be 0.3 to 1.1 V, 0.4 to 1.0 V, 0.5 to 0.9 V, or 0.6 to 0.8 V. The sacrificial metal included in the sacrificial metal particles may have the standard reduction potential within the range described above and also have a value less than the standard reduction potential of the active metal included in the active metal particles.

According to an exemplary embodiment, the active metal particles may include one or more metals selected from the group consisting of palladium (Pd); platinum (Pt); gold (Au); ruthenium (Ru); rhodium (Rh); iridium (Ir); osmium (Os); and alloys including the metals. The metal included in the active metal particles is appropriately selected from the metals described above and may have the effect described above, but the active metal included in the active metal particles included in the composite of the present invention is not limited to the metals described above, and may be any metal as long as the active metal included in the active metal particles and the sacrificial metal included in the sacrificial metal particles are appropriately selected, respectively, and have the effect described above.

In addition, according to an exemplary embodiment, the sacrificial metal particles may include one or more metals selected from the group consisting of silver (Ag); palladium (Pd); iridium (Ir); ruthenium (Ru); rhodium (Rh); platinum (Pt); osmium (Os); iron (Fe); aluminum (Al); and alloys including the metals. As a non-limiting example of the alloy included in the sacrificial metal particles, the alloy included in the sacrificial metal particles may include silver-zinc (AgZn), silver-tin (AgSn), silver-antimony (AgSb), silver-indium (AgIn), ferrochrome (FeCr), ferromolybdenum (FeMo), ferromanganese (FeMn), ferrotungsten (Few), ferronickel (FeNi), or iron-chromium-nickel (FeCrNi), and the like, but the present invention is not limited thereto.

The metal included in the sacrificial metal particles is appropriately selected from the metals described above and may have the effect described above, but the sacrificial metal included in the sacrificial metal particles included in the composite of the present invention is not limited to the metals described above, and may be any metal as long as the sacrificial metal included in the sacrificial metal particles and the active metal included in the active metal particles are appropriately selected, respectively, and have the effect described above.

As a non-limiting and favorable example, the active metal may include platinum (Pt), and the sacrificial metal may include silver (Ag) so that oxidation of the platinum may be suppressed by silver.

According to an exemplary embodiment, the active metal may include platinum (Pt), and a difference between a 2θ value of a maximum peak shown in a range of 2θ=39.8±1.0° in an X-ray diffraction (XRD) spectrum of the composite and a 2θ value of a maximum peak shown in a range of 2θ=39.8±1.0° in an X-ray diffraction (XRD) spectrum of pure platinum (Pt) may be 0.3° or less. The difference in the 2θ value may be 0.3° or less or 0.2° or less, and more specifically 0.1° or less, and its lower limit may be 0°, 0.01°, or 0.05°. Specifically, the difference in the 20 value may be 0.05 to 0.3°, 0.01 to 0.3°, or 0 to 0.1°. In the composite satisfying the difference in the 2θ value, platinum (Pt) particles which are the active metal particles and the sacrificial metal particles do not form an alloy with each other, so that the composite may have excellent catalytic activity. As a non-limiting and favorable example, the composite may have a maximum peak in a range of 2θ=39.8±0.2° in the X-ray diffraction (XRD) spectrum.

According to an exemplary embodiment, the active metal may include platinum (Pt), and the composite may have a ratio (I₀/I_{II}) between a Pt (0) peak intensity (I₀) and Pt(II) peak intensity (I_{II}) in the Pt 4f_{7/2} XPS spectrum by X-ray photoelectron spectroscopy (XPS) of 1.8 or more, preferably 2.0 or more, and more preferably 2.2 or more, and its upper limit may be 3.5 or 3.0. Since the composite satisfying the ratio between the peaks in the range described above has a high ratio of a metallic platinum component in platinum included in the composite, degradation of platinum may be more effectively suppressed, and thus, the composite may have better catalytic activity and durability.

According to an exemplary embodiment, the active metal may include platinum (Pt), the composite may have a peak in a range of 11567.2±0.2 eV in an X-ray absorption near-edge structure (XANES) spectrum, and since the composite having the peak in the range described above has a high ratio of the metallic platinum component in platinum included therein, degradation of platinum may be more effectively suppressed, and thus, catalytic activity and durability may be better.

According to an exemplary embodiment, an atomic ratio of sacrificial metal:active metal included in the composite may be 1:0.1 to 1:50, specifically 1:0.5 to 1:15, more specifically 1:1 to 1:10, and still more specifically 1:2 to 1:8, or 1:3 to 1:8. Since the ratio between the sacrificial metal and the active metal is selected within the range described above, the composite may have significantly improved durability while maintaining excellent catalytic activity. When the sacrificial metal included in the composite is included in an excessive amount beyond the range described above, catalytic activity may be lowered. In addition, when the sacrificial metal included in the composite is included below the range described above, the effect of the sacrificial metal being oxidized or reduced instead of the active metal is decreased to lower the durability of the composite. As a favorable example, the total number of atoms of the sacrificial metal is larger than the total number of atoms of the active metal within the range described above, so that the sacrificial metal may be oxidized or reduced instead of the active metal to increase the durability of the composite.

According to an exemplary embodiment, the active metal particles and the sacrificial metal particles may have any one or more shapes selected from the group consisting of spherical, angular, linear, and amorphous shapes, but the shape of the active metal particles and the sacrificial metal particles is not particularly limited in the present invention.

According to an exemplary embodiment, an average particle diameter of the active metal particles and/or the sacrificial metal particles may be 0.1 nm to 20 nm, specifically 1 nm to 10 nm, and more specifically 1 nm to 5 nm, but the composite according to the present invention is not necessarily limited to the average particle diameter of the active metal particles described above and/or the sacrificial metal particles described above.

According to an exemplary embodiment, the composite may have a ratio (D₂/D₁) between the average particle diameter (D₂) of the active metal particles after the accelerated durability test (ADT) of the cycles of the composite and the average particle diameter (D₁) of the active metal particles before the accelerated durability test of 3 or less. Specifically, the ratio of D₂/D₁ may be 0.5 or more, 1 or more, or 1.5 or more, and its upper limit may be 4 or less, 3 or less, or 2.5 or less. Specifically, the ratio of D₂/D₁ may be 0.5 to 4, 1 to 3, or 1.5 to 2.5. Since the degradation of the active metal may mean an effect which is shown to be more suppressed by the sacrificial metal, the composite satisfying the ratio of the average particle diameters described above may mean a composite having more significantly improved catalytic activity and durability.

As the conditions for performing the accelerated durability test (ADT), proposals from the U.S. Department of Energy (DOE) may be applied, and specifically, the accelerated durability test may be performed by supplying pure hydrogen at a relative humidity of 100% at a flow rate of 100 sccm to an anode at 80° C. under atmospheric pressure, and supplying pure nitrogen at a relative humidity of 100% at a flow rate of 50 sccm to a cathode, and one cycle of ADT may include a maintenance section of 3 seconds at 0.6 V, a rising section of 0.5 seconds, and a maintenance section of 3 seconds at 0.95 V.

According to an exemplary embodiment, any carbon support included in the composite may be used without limitation as long as it is a carbon support which is known in the art and includes carbon having excellent chemical stability and electroconductivity. As a non-limiting example, the carbon support may be one or more selected from Vulcan carbon, carbon paper, carbon filter, carbon fiber, acetylene black, carbon black, Ketjen black, carbon nanotubes, graphene, Timcal, and other heteroelement-doped carbons, but the present invention is not particularly limited thereto.

According to an exemplary embodiment, a content of the active metal particles supported on the carbon support may be 1 to 40 wt %, specifically 4 to 30 wt %, and more specifically 5 to 24 wt %, based on the total weight of the composite.

According to an exemplary embodiment, a content of the sacrificial metal particles supported on the carbon support may be 0.5 to 20 wt %, specifically 2 to 15 wt %, and more specifically 2.5 to 12 wt %, based on the total weight of the composite.

According to an exemplary embodiment, the composite may be a catalyst for an oxygen reduction reaction (ORR). As described above, the composite including the carbon support, the active metal particles, and the sacrificial metal particles in which the active metal particles and the sacrificial metal particles are independently supported on the carbon support may be used as a catalyst having excellent activity in the oxygen reduction reaction and having significantly excellent stability as compared with a conventional pure active metal catalyst.

FIG. 1 is a schematic diagram for describing an effect of whether silver (Ag) particles which are the sacrificial metal particles are included on catalytic activity of the oxygen reduction reaction (ORR), as a more specific exemplary embodiment. Referring to FIG. 1, platinum (Pt) particles in a pure platinum catalyst (Pt/C) may be oxidized in anode potential scan to produce Pt—O, and Pt—O may be reduced in cathode potential scan to return to Pt—O, but due to reduction failure of some Pt—O, platinum is present in an ion state (Pt²⁺), which may cause dissolution of platinum to cause degradation of platinum. However, in the composite according to the present invention (indicated as Ag+Pt/C in FIG. 1), silver (Ag) particles having lower standard reduction potential than platinum may be oxidized before platinum to prevent oxidation of platinum. As a result, the composite according to the present invention may produce much less Pt—O than the pure platinum catalyst to greatly decrease degradation of platinum, and platinum abundant in electrons may polarize oxygen molecules into oxygen atoms to implement more stable oxygen reduction reaction (ORR) performance.

The present invention provides an electrode for a fuel cell including the composite described above. In addition, the present invention provides a fuel cell including the electrode for a fuel cell. The fuel cell according to the present invention may include an anode which produces hydrogen ions and electrons by oxidation of a fuel material, a cathode in which reduction of oxygen occurs by a reaction of hydrogen ions and electrons, and an electrode layer (membrane) which may efficiently transfer hydrogen ions from the anode to the cathode, and since the cathode includes the composite according to the present invention, stability as well as efficiency of the fuel cell may be improved.

According to an exemplary embodiment, the fuel cell may be a proton exchange membrane fuel cell (PEMFC), a direct methanol fuel cell (DMFC) which uses alcohol as fuel, a direct ethanol fuel cell (DEFC), an alkaline fuel cell (AFC), a phosphoric acid fuel cell (PAFC), a molten carbonate fuel cell (MCFC), a solid oxide fuel cell (SOFC), and the like, but the present invention is not particularly limited to the type of the fuel cells.

According to an exemplary embodiment, the fuel cell may be a proton exchange membrane fuel cell (PEMFC) which may be operated at a low temperature and applied to transportation, and the proton exchange membrane fuel cell may include a first gas diffusion layer, an anode, a polymer electrolyte membrane, a cathode, and a second gas diffusion layer. Herein, hydrogen (H₂) as a raw material is supplied to the anode through the first gas diffusion layer, the supplied hydrogen is oxidized in the anode and produces hydrogen ions, and the produced hydrogen ions may be transferred to the cathode through the polymer electrolyte membrane. On the cathode, the hydrogen ions react with the oxygen supplied to the cathode through the second gas diffusion layer to produce water as described above, and at this time, since catalytic activity for the oxygen reduction reaction (ORR) is excellent and durability may be significantly excellent by the composite according to the present invention included in the cathode, the stability of the fuel cell may be improved.

According to an exemplary embodiment, the first gas diffusion layer and the second gas diffusion layer may include materials to which raw materials, or air and/or oxygen to be supplied may be supplied well and which include electroconductivity and are well known in the art, but the present invention is not limited thereto.

According to an exemplary embodiment, the fuel cell may have a decrease rate of energy density after the accelerated durability test (ADT) of 30,000 cycles of 40% or less, 30% or less, 25% or less, or 20% or less, and as a lower limit, 1% or more, 5% or more, 10% or more, or 15% or more. Specifically, the decrease rate of energy density of the fuel cell after the accelerated durability test of 30, 000 cycles may be 1 to 40%, 5 to 30%, 10 to 25%, or 15 to 20%. The fuel cell includes the composite described above, thereby maintaining high energy density even after the accelerated durability test of 30,000 cycles or more.

According to an exemplary embodiment, as the conditions for performing the accelerated durability test (ADT) of 30,000 cycles, proposals from the U.S. Department of Energy (DOE) may be applied, and specifically, the accelerated durability test may be performed by supplying pure hydrogen at a relative humidity of 100% at a flow rate of 100 sccm to the anode at 80° C. under ambient pressure, and supplying pure nitrogen at a relative humidity of 100% at a flow rate of 50 sccm to the cathode, and one cycle of the accelerated durability test may include a maintenance section of 3 seconds at 0.6 V, a rising section of 0.5 seconds, and a maintenance section of 3 seconds at 1.0 V.

The present invention provides a method for manufacturing a composite, and the method for manufacturing a composite includes: mixing a dispersion including a carbon support on which active metal particles are supported and a solution including a sacrificial metal precursor to prepare a first reaction solution; and adding a reducing agent to the first reaction solution to synthesize a composite in which the active metal particles and sacrificial metal particles are independently supported on the carbon support.

The present invention provides another method for manufacturing a composite, and the method for manufacturing a composite includes: mixing a dispersion including a carbon support on which active metal particles are supported and a dispersion including a carbon support on which sacrificial metal particles are supported to prepare a second reaction solution; and adding a reducing agent to the second reaction solution to synthesize a composite in which the active metal particles and the sacrificial metal particles are independently supported on the carbon support.

In describing each of the methods for manufacturing a composite according to the present invention, since the carbon support, the active metal particles, the sacrificial metal particles, and the like are identical or similar to the above description for the composite, the method for manufacturing a composite according to the present invention includes all of the above descriptions for the composite.

Hereinafter, the method for manufacturing a composite according to the present invention will be described in detail. In addition, the method for manufacturing a composite and another method for manufacturing a composite are collectively referred to as a method for manufacturing a composite.

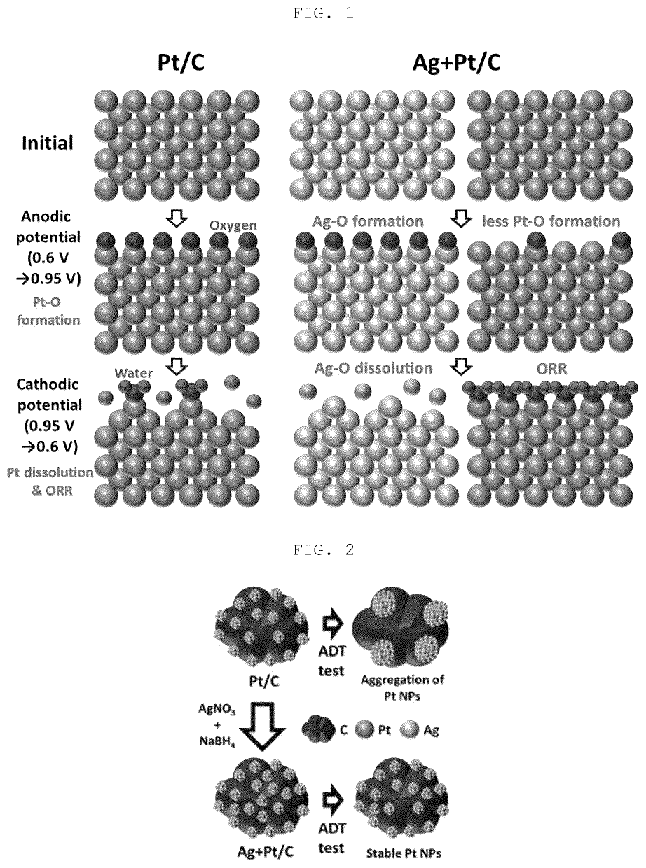

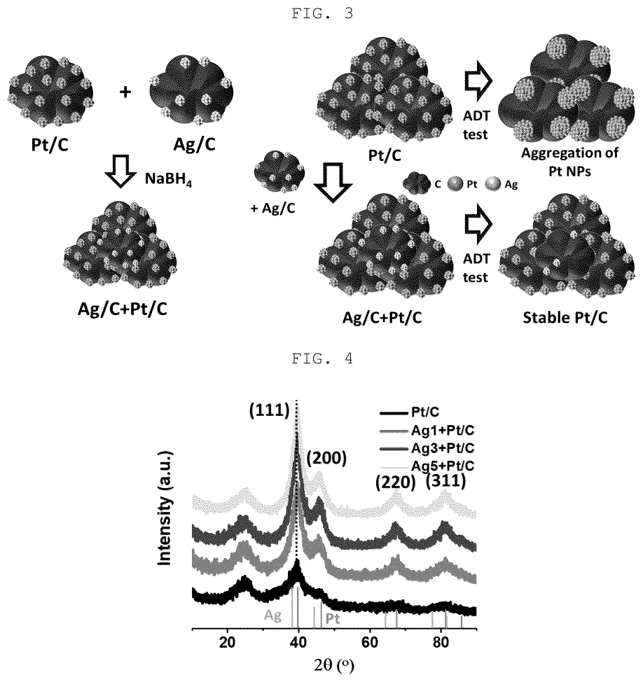

FIGS. 2 and 3 are schematic diagrams of the method for manufacturing a composite according to an exemplary embodiment of the present invention. Referring to FIGS. 2 and 3, the method for manufacturing a composite according to the present invention will be described, but this is for helping understanding of the present invention and the present invention is not limited by the drawings.

Referring to FIG. 2, the method for manufacturing a composite according to an exemplary embodiment may produce a composite in which active metal particles and sacrificial metal particles are independently supported on a carbon support by a simple method, and the composite manufactured by the method for manufacturing a composite may effectively suppress degradation of the active metals, thereby having significantly improved durability as compared with a conventional noble metal-based catalyst while maintaining excellent catalytic activity of a noble metal-based catalyst.

According to an exemplary embodiment, in the preparing of a first reaction solution, 0.5 to 20 parts by weight, specifically 2 to 15 parts by weight, specifically 2.5 to 12 parts by weight of the sacrificial metal precursor may be used with respect to 100 parts by weight of the carbon support on which the active metal particles are supported.

According to an exemplary embodiment, a dispersion solvent included in the dispersion and the solution including a sacrificial metal precursor in the preparing of a first reaction solution may be one or more solvents selected from the group consisting of water, isopropanol, toluene, ethanol, n-propanol, n-butylacetate, ethylene glycol, butyl carbitol, and butyl carbitol acetate, but the present invention is not limited to the solvents, and an appropriate solvent may be selected depending on a chemical species included in the carbon support on which the active metal particles are supported and the sacrificial metal precursor.

According to an exemplary embodiment, the sacrificial metal precursor may be a chloride, an iodide, a sulfide, a fluoride, a hydroxide, a carbonate, and/or a nitrate including a metal having a lower standard reduction potential than an active metal included in the active metal particles. As a non-limiting example, since the sacrificial metal may be silver (Ag), the sacrificial metal precursor may be silver nitrate (AgNO₃).

According to an exemplary embodiment, the reducing agent in the synthesizing of a composite may be one or more reducing agents selected from the group consisting of sodium hydride (NaH), sodium borohydride (NaBH₄), lithium tetrahydroaluminate (LiAlH₄), hydrizine (N₂H₄), diisobutylaluminum hydride (DIBAH), and potassium triethyl borohydride (KEt₃BH).

Referring to FIG. 3, in another method for manufacturing a composite according to an exemplary embodiment, in the preparing of a second reaction solution, the active metal and/or the sacrificial metal included in the carbon support on which the active metal particles are supported and the carbon support on which the sacrificial metal particles are supported may be in a state in which all or a part does not complete the reduction reaction.

In the synthesizing of a composite which is included in another method for manufacturing a composite according to an exemplary embodiment, the reduction reaction performed using the reducing agent may be performed at 25 to 200° C., but the present invention is not particularly limited thereto.

Since the information on the dispersion solvent and the reducing agent included in another method for manufacturing a composite according to an exemplary embodiment is the same as that included in the method for manufacturing a composite described above, detailed description thereof will be omitted.

According to an exemplary embodiment, there may be a third method for manufacturing a composite. The third manufacturing method may include: mixing a carbon support on which active metal particles are support and a carbon support on which sacrificial metal particles are supported to prepare a mixture; and heating the mixture to synthesize a composite in which the active metal particles and the sacrificial metal particles are independently supported on the carbon support.

According to an exemplary embodiment, a temperature to heat the mixture in the third method for manufacturing a composite may be 100° C. or higher, 150° C. or higher, or 200° C. or higher, and as an upper limit, 600° C. or lower, 500° C. or lower, or 400° C. or lower. Specifically, the temperature to heat the mixture may be 100 to 600° C., 150 to 500° C., or 200 to 400° C.

According to an exemplary embodiment, the heating of the mixture to synthesize a composite in which the active metal particles and the sacrificial metal particles are independently supported on the carbon support may be performed under a mixed gas atmosphere of one or two or more selected from the group consisting of inert gases such as nitrogen, helium, and argon; hydrogen gas; and ammonia.

The third method for manufacturing a composite may produce a composite in which active metal particles and sacrificial metal particles are independently supported on a carbon support by a simple method, like the method for manufacturing a composite described above, and the composite manufactured by the manufacturing method may effectively suppress degradation of the active metals, thereby having significantly improved durability as compared with a conventional noble metal-based catalyst while maintaining excellent catalytic activity of a noble metal-based catalyst. The active metal may be one or more selected from the group consisting of palladium (Pd); platinum (Pt); gold (Au); ruthenium (Ru); rhodium (Rh); iridium (Ir); osmium (Os); and alloys including the metals, and the sacrificial metal may be selected from the metals having a lower standard reduction potential than the selected active metal.

The present invention provides a membrane electrode assembly, and the membrane electrode assembly includes: a cathode including a first catalyst layer and a first gas diffusion layer; an anode including a second catalyst layer and a second gas diffusion layer; and a polymer electrolyte membrane disposed between the cathode and the anode, wherein the first catalyst layer includes active metal particles, and the first gas diffusion layer includes a support for the first gas diffusion layer; and sacrificial metal particles which are supported on the support for the first gas diffusion layer and are oxidized or reduced instead of the active metal particles.

In the description of the membrane electrode assembly according to the present invention, since the descriptions of the active metal particles, the sacrificial metal particles, and the like are identical or similar to the above descriptions, the membrane electrode assembly according to the present invention includes all of the above descriptions for the composite.

Hereinafter, the membrane electrode assembly of the present invention will be described in more detail.

In the membrane electrode assembly according to an exemplary embodiment, since a gas diffusion layer for a cathode, that is, the first gas diffusion layer, includes the sacrificial metal particles, degradation of an active metal included in a catalyst layer for a cathode, that is, the first catalyst layer, may be effectively suppressed, so that the membrane electrode assembly may have significantly improved durability as compared with a conventional membrane electrode assembly including no sacrificial metal particles.

FIG. 30 is a drawing showing a schematic diagram of a membrane electrode assembly according to an exemplary embodiment of the present invention. Specifically, the membrane electrode assembly according to an exemplary embodiment may have a structure in which a first gas diffusion layer 10, a first catalyst layer 20, a polymer electrolyte membrane 30, a second catalyst layer (or catalyst layer for an anode, not shown), and a second gas diffusion layer (or gas diffusion layer for an anode) are laminated in order.

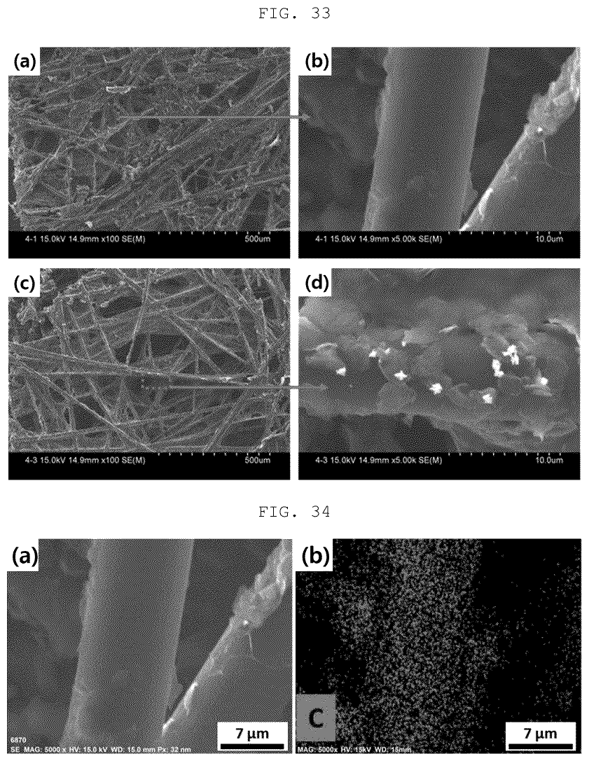

FIG. 31 is a drawing showing an operation principle of a fuel cell depending on inclusion of sacrificial metal particles. Specifically, (a) of FIG. 31 is a drawing showing the case of using a gas diffusion layer which does not include sacrificial metal particles 2, and degradation of the active metal particles occurs as the fuel cell is operated. However, (b) of FIG. 31 is a drawing showing the case of using the gas diffusion layer 10 including the sacrificial metal particles 2, and as the fuel cell is operated, the sacrificial metal particles 2 may be oxidized before the active metal particles to effectively suppress oxidation of the active metal particles, thereby solving the degradation of the active metal particles. Accordingly, catalytic activity life may be significantly extended, and the performance of the fuel cell to which the case is applied may be maintained over a long period of time. In addition, since the present invention includes the sacrificial metal particles 2 on the support 1 for the first gas diffusion layer, unlike a conventional technology which covers the catalytic active site of the active metal by coating a surface of the active metal particles in order to suppress degradation, the sacrificial metal particles 2 do not cover the catalytic active site of the active metal, and excellent catalytic activity of the active metal catalyst may be maintained. That is, the membrane electrode assembly of the present invention may have excellent catalytic activity, and also significantly improved durability.

According to an exemplary embodiment, one surface of the support for the first gas diffusion layer on which the sacrificial metal particles are placed may face one surface of the first catalyst layer. Specifically, the sacrificial metal particles included in the support for the first gas diffusion layer may be in direct contact with one surface of the first catalyst layer. Therefore, the sacrificial metal particles included in the support for the first gas diffusion layer may suppress oxidation of the active metal particles included in the first catalyst layer more effectively.

According to an exemplary embodiment, the second catalyst layer and the second gas diffusion layer included in the anode may include materials which are well known in the art for forming an anode. As an example, the anode may include a second catalyst layer including the active metal particles; and a second gas diffusion layer including a support for the second gas diffusion layer. That is, the support for the second gas diffusion layer may not include the sacrificial metal particles.

According to an exemplary embodiment, the second catalyst layer may include the active metal particles, and the second gas diffusion layer may include a support for the second gas diffusion layer; and the sacrificial metal particles which are supported on the support for the second gas diffusion layer and are oxidized or reduced instead of the active metal particles. Specifically, the second catalyst layer may include the active metal particles, and the second gas diffusion layer may include a support for the second gas diffusion layer; and the sacrificial metal particles which are supported on the support for the second gas diffusion layer and include a sacrificial metal which is oxidized or reduced instead of the active metal. In addition, when the second gas diffusion layer includes the sacrificial metal particles, one surface of the support for the second gas diffusion layer on which the sacrificial metal particles are placed may face one surface of the second catalyst layer.

According to an exemplary embodiment, the active metal particles included in the second catalyst layer and the active metal particles included in the first catalyst layer may have different compositions from each other. In addition, the sacrificial metal particles supported on the support for the first gas diffusion layer and the sacrificial metal particles supported on the support for the second gas diffusion layer may also have different compositions from each other. As a non-limiting example, in the membrane electrode assembly according to an exemplary embodiment of the present invention, the active metal particles included in the first catalyst layer may include palladium (Pd), the active metal particles included in the second catalyst layer may include platinum (Pt), the sacrificial metal particles included in the first gas diffusion layer may include silver (Ag), and the sacrificial metal particles included in the second gas diffusion layer may include aluminum (Al).

According an exemplary embodiment, a metal included in the sacrificial metal particles, that is, a sacrificial metal, may have a lower standard reduction potential than a metal included in the active metal particles, that is, an active metal. The active metal included in the active metal particles may be any metal which has a higher standard reduction potential than the sacrificial metal included in the sacrificial metal particles while having catalytic activity.

According to an exemplary embodiment, the standard reduction potential of the active metal included in the active metal particles may be 0.7 V or more, 0.8 V or more, 0.9 V or more, or 1.0 V or more and as an upper limit, 3.0 V or less, 2.5 V or less, 2.0 V or less, or 1.5 V or less. Specifically, the standard reduction potential of the active metal included in the active metal particles may be 0.7 to 3.0 V, 0.8 to 2.5 V, 0.9 to 2.0 V, or 1.0 to 1.5 V.

According to an exemplary embodiment, the standard reduction potential of the sacrificial metal included in the sacrificial metal particles may be 0.3 V or more, 0.4 V or more, 0.5 V or more, or 0.6 V or more and as an upper limit, 1.1 V or less, 1.0 V or less, 0.9 V or less, or 0.8 V or less. Specifically, the standard reduction potential of the sacrificial metal included sacrificial metal particles may be 0.3 to 1.1 V, 0.4 to 1.0 V, 0.5 to 0.9 V, or 0.6 to 0.8 V. The sacrificial metal included in the sacrificial metal particles may have the standard reduction potential within the range described above and also have a value less than the standard reduction potential of the active metal included in the active metal particles.

According to an exemplary embodiment, the active metal particles may include one or more metals selected from the group consisting of palladium (Pd); platinum (Pt); gold (Au); ruthenium (Ru); rhodium (Rh); iridium (Ir); osmium (Os); and alloys including the metals. The metal included in the active metal particles is appropriately selected from the metals described above and may have the effect described above, but the active metal included in the active metal particles included in the membrane electrode assembly of the present invention is not limited to the metals described above, and may be any metal as long as the active metal included in the active metal particles and the sacrificial metal included in the sacrificial metal particles are appropriately selected, respectively, and have the effect described above.

In addition, according to an exemplary embodiment, the sacrificial metal particles may include one or more metals selected from the group consisting of silver (Ag); palladium (Pd); iridium (Ir); ruthenium (Ru); rhodium (Rh); platinum (Pt); osmium (Os); iron (Fe); aluminum (Al); and alloys including the metals. As a non-limiting example of the alloy included in the sacrificial metal particles, the alloy may include silver-zinc (AgZn), silver-tin (AgSn), silver-antimony (AgSb), silver-indium (AgIn), ferrochrome (FeCr), ferromolybdenum (FeMo), ferromanganese (FeMn), ferrotungsten (FeW), ferronickel (FeNi), or iron-chromium-nickel (FeCrNi), and the like, but the present invention is not limited thereto.

The metal included in the sacrificial metal particles is appropriately selected from the metals described above and may have the effect described above, but the sacrificial metal included in the sacrificial metal particles included in the membrane electrode assembly of the present invention is not limited to the metals described above, and may be any metal as long as the sacrificial metal included in the sacrificial metal particles and the active metal included in the active metal particles are appropriately selected, respectively, and have the effect described above.

As a non-limiting and favorable example, the active metal may include platinum (Pt), and the sacrificial metal may include silver (Ag) so that oxidation of the platinum may be suppressed by silver.

According to an exemplary embodiment, the sacrificial metal particles and the active metal particles may have any one or more shapes selected from the group consisting of spherical, angular, linear, and amorphous shapes, but the shape of the sacrificial metal particles and/or the active metal particles is not particularly limited in the present invention.

According to an exemplary embodiment, an average particle diameter of the active metal particles and/or the sacrificial metal particles may be 0.1 nm to 20 nm, specifically 1 nm to 10 nm, and more specifically 1 nm to 5 nm, but the composite according to the present invention is not necessarily limited to the average particle diameter of the active metal particles described above and/or the sacrificial metal particles described above.

According to an exemplary embodiment, the first catalyst layer may have a ratio (I₂/I₁) between a Pt(II) peak intensity (I₂) after the accelerated durability test (ADT) of 90,000 cycles and a Pt(II) peak intensity (I₁) before the accelerated durability test in a Pt 4f XPS spectrum by X-ray photoelectron spectroscopy (XPS) of 0.5 or more, specifically 0.6 or more, and more specifically 0.7 or more, and an example of the upper limit may be 1.0. Herein, the ratio of the peak intensities described above may be measured by a Pt 4f_{7/2} XPS spectrum. Since the membrane electrode assembly has a smaller change in the peak intensity depending on the electrochemical reaction of the first catalyst layer included in the membrane electrode assembly, the degradation of platinum may be suppressed more effectively, and thus, the membrane electrode assembly may have better catalytic activity and durability.

Herein, as the conditions for performing the accelerated durability test (ADT) of 90,000 cycles, the proposals in the Million Mile Fuel Cell Truck (M2FCT) protocol may be applied. Specifically, the accelerated durability test may be performed by supplying pure hydrogen at a relative humidity of 100% at a flow rate of 100 sccm to the anode at 80° C. under ambient pressure, and supplying pure nitrogen at a relative humidity of 100% at a flow rate of 50 sccm to the cathode, and one cycle of the accelerated durability test may include a maintenance section of 3 seconds at 0.6 V, a rising section of 0.5 seconds, and a maintenance section of 3 seconds at 1.0 V.

In an exemplary embodiment, a ratio (D₂/D₁) between an average particle diameter (D₂) of the active metal particles after the accelerated durability test (ADT) of 30,000 cycles and an average particle diameter (D₁) of the active metal particles before the accelerated durability test may be 3 or less, specifically 2.5 or less, more specifically 2 or less, and still more specifically 1.5 or less, and the lower limit may be 1. Since the degradation of the active metal may mean an effect which is shown to be more suppressed by the sacrificial metal, the membrane electrode assembly satisfying the ratio of the average particle diameters described above may mean a membrane electrode assembly having more significantly improved catalytic activity and durability.

Herein, as the conditions for performing the accelerated durability test (ADT) of 30,000 cycles, proposals from the U.S. Department of Energy (DOE) may be applied, and specifically, the accelerated durability test may be performed by supplying pure hydrogen at a relative humidity of 100% at a flow rate of 100 sccm to the anode at 80° C. under ambient pressure, and supplying pure nitrogen at a relative humidity of 100% at a flow rate of 50 sccm to the cathode, and one cycle of the accelerated durability test may include a maintenance section of 3 seconds at 0.6 V, a rising section of 0.5 seconds, and a maintenance section of 3 seconds at 1.0 V.

According to an exemplary embodiment, a content of the sacrificial metal particles per unit area of the support for the first gas diffusion layer may be 0.1 to 100 mg/cm², specifically 0.1 to 50 mg/cm², specifically 0.1 to 20 mg/cm², and more specifically 0.1 to 10 mg/cm², but the content of the sacrificial metal particles included in the membrane electrode assembly according to the present invention is not particularly limited thereto. However, when the content of the sacrificial metal particles per unit area of the support for the first gas diffusion layer satisfies the range described above, the membrane electrode assembly may have significantly improved durability. When the support for the first gas diffusion layer includes the sacrificial metal particles in the below the range described above, it may be difficult to suppress the degradation of the active metal, and when the support for the first gas diffusion layer includes the sacrificial metal particles in excess of the range described above, catalytic activity may be decreased to deteriorate performance of a fuel cell including the membrane electrode assembly.

According to an exemplary embodiment, an atomic ratio between the sacrificial metal included in the sacrificial metal particle included in the first gas diffusion layer and the active metal included in the active metal particles included in the first catalyst layer may be 0.1:1 to 100:1. The atomic ratio between the sacrificial metal included in the sacrificial metal particle included in the first gas diffusion layer and the active metal included in the active metal particles included in the first catalyst layer may be 0.1 mol or more, 0.5 mol or more, 1 mol or more, 2 mol or more, 3 mol or more, or 10 mol or more and as the upper limit, 100 mol or less, 90 mol or less, 80 mol or less, 70 mol or less, 60 mol or less, 50 mol or less, or 30 mol or less of the sacrificial metal, based on 1 mol of the active metal. Specifically, the atomic ratio between the sacrificial metal included in the sacrificial metal particle included in the first gas diffusion layer and the active metal included in the active metal particles included in the first catalyst layer may be 0.1 to 100 mol, 0.5 to 90 mol, 1 to 80 mol, 3 to 70 mol, 5 to 60 mol, 10 to 50 mol, or 10 to 30 mol of the sacrificial metal, based on 1 mol of the active metal. As a favorable example, the total number of atoms of the sacrificial metal is larger than the total number o atoms of the active metal, so that the sacrificial metal may be oxidized or reduced instead of the active metal to increase the durability of the membrane electrode assembly.

According to an exemplary embodiment, a ratio of the sacrificial metal to the active metal included in the membrane electrode assembly may be higher than a ratio of the sacrificial metal to the active metal included in the composite. Specifically, the ratio of active metal:sacrificial metal of the membrane electrode assembly and the composite may be selected within the range described above. However, the membrane electrode assembly may not have lowered catalytic activity even when it includes a higher ratio of the sacrificial metal than the composite under optimal conditions. Therefore, the membrane electrode assembly has equivalent catalytic activity and higher durability though it includes more sacrificial metal than the composite. In addition, the membrane electrode assembly may have equivalent durability and higher catalytic activity though it includes sacrificial metal in a similar amount to the composite.

According to an exemplary embodiment, the support for the first gas diffusion layer and the support for the second gas diffusion layer may include carbon-based materials, and the carbon-based material may be used without limitation as long as it is a material to which fuel material, air, or oxygen to be supplied may be supplied well and which has electroconductivity and is well known in the art, and there is no limitation even if a person skilled in the art synthesizes the carbon-based material with common technical knowledge, or purchases and uses a commercially available material. As a non-limiting example, the carbon-based material may be one or more selected from Vulcan carbon, carbon paper, carbon filter, carbon fiber, acetylene black, carbon black, Ketjen black, carbon nanotubes, graphene, Timcal, and other heteroelement-doped carbons, but the membrane electrode assembly according to the present invention is not particularly limited thereto. The support for the first gas diffusion layer and the support for the second gas diffusion layer may be supports formed of the same material, or supports formed of different materials from each other.

According to an exemplary embodiment, when the membrane electrode assembly is applied to a fuel cell which is one of the energy conversion devices, the first catalyst layer may include a catalyst for an oxygen reduction reaction (ORR), and the second catalyst layer may include a catalyst for a hydrogen oxidation reaction (HOR). Specifically, the first catalyst layer and the second catalyst layer may be the active metal particles being supported on the support for the first catalyst layer and the support for the second catalyst layer.

According to an exemplary embodiment, when the membrane electrode assembly is applied to a water splitting reaction which is one of the energy conversion devices, the first catalyst layer may include a catalyst for a hydrogen evolution reaction (HER), and the second catalyst layer may include a catalyst for an oxygen evolution reaction (OER). Specifically, the first catalyst layer and the second catalyst layer may be the active metal particles being supported on the support for the first catalyst layer and the support for the second catalyst layer.

According to an exemplary embodiment, contents of the active metal particles supported on the support for the first catalyst layer and the support for the second catalyst layer may be 1 to 80 wt %, specifically 4 to 40 wt %, and more specifically 5 to 24 wt %, based on the total weight of the first catalyst layer or the second catalyst layer, respectively, but the membrane electrode assembly according to the present invention is not particularly limited thereto.

According to an exemplary embodiment, the support for the first catalyst layer and the support for the second catalyst layer may include carbon-based materials, and the carbon-based material may be used without limitation as long as it is a material which is known in the art, includes carbon, and has excellent chemical stability and electroconductivity, and there is no limitation even if a person skilled in the art synthesizes the carbon-based material with common technical knowledge, or purchases and uses a commercially available material. As a non-limiting example, the carbon-based material may be one or more selected from Vulcan carbon, carbon paper, carbon filter, carbon fiber, acetylene black, carbon black, Ketjen black, carbon nanotubes, graphene, Timcal, and other heteroelement-doped carbons, but is not particularly limited thereto. The support for the first catalyst layer and the support for the second catalyst layer may be supports formed of the same material, or supports formed of different materials from each other.

The present invention provides another fuel cell, and the fuel cell includes the membrane electrode assembly described above. Another fuel cell may be a fuel cell different from the above fuel cell including the composite according to the present invention, but since the working effects of the sacrificial metal particles and the active metal particles are identical or similar to each other, another fuel cell including the membrane electrode assembly includes all of the above descriptions for the fuel cell including the composite. In addition, hereinafter, in describing another fuel cell, another fuel cell is collectively referred to as a fuel cell.

The present invention provides a fuel cell including the membrane electrode assembly described above, and the fuel cell, that is, an energy conversion device, has improved performance, in particular, significantly improved durability to maintain the performance of the energy conversion device for a long period of time, by including the membrane electrode assembly. Specifically, the fuel cell has high retention rates of electrochemical active surface area, (ECSA), maximum current density, current density, and activity per unit mass (mass activity) even after the accelerated durability test (ADT) under harsh conditions, and may significantly reduce an increase in charge transfer resistance.

According to an exemplary embodiment, the fuel cell may have a retention rate of maximum current density after the accelerated durability test (ADT) of 30,000 cycles of 80% or more, specifically 85% or more, more specifically 90% or more, and still more specifically 95% or more as compared with a retention rate before the accelerated durability test. In addition, the fuel cell may have a retention rate of maximum current density after the accelerated durability test of 90,000 cycles, which is harsher conditions, of 70% or more, specifically 75% or more, and more specifically 80% or more as compared with a retention rate before the accelerated durability test.

According to an exemplary embodiment, the fuel cell may have a retention rate of current density at 0.2 V after the accelerated durability test (ADT) of 30,000 cycles of 80% or more, specifically 85% or more, more specifically 90% or more, and still more specifically 95% or more as compared with a retention rate before the accelerated durability test. In addition, the fuel cell may have a retention rate of current density at 0.2 V after the accelerated durability test of 90,000 cycles, which is harsher conditions, of 70% or more, specifically 75% or more, and more specifically 80% or more as compared with a retention rate before the accelerated durability test.

According to an exemplary embodiment, the fuel cell may have a retention rate of mass activity at 0.9 V after the accelerated durability test (ADT) of 30,000 cycles of 60% or more, specifically 70% or more, more specifically 80% or more, and still more specifically 90% or more or 95% or more as compared with a retention rate before the accelerated durability test. In addition, the fuel cell may have a retention rate of mass activity at 0.9 V after the accelerated durability test of 90,000 cycles, which is harsher conditions, of 50% or more, specifically 60% or more, and more specifically 75% or more as compared with a retention rate before the accelerated durability test.

The fuel cell according to the present invention is one of the energy conversion devices, and the energy conversion device may include the fuel cell, a water electrolysis battery, and the like. Therefore, the membrane electrode assembly and/or the composite is used also in the water electrolysis battery and may have a similar remarkable effect.

According to an exemplary embodiment, as a non-limiting example of the fuel cell, the fuel cell may be a proton exchange membrane fuel cell (PEMFC) which is operated at a low temperature and may be applied to transportation.

The present invention provides a method for manufacturing a membrane electrode assembly, and the method for manufacturing a membrane electrode assembly includes: 1) doping a sacrificial metal precursor on a support for a first gas diffusion layer; 2) reducing the sacrificial metal precursor doped on the support for a first gas diffusion layer to prepare a first gas diffusion layer in which sacrificial metal particles are supported on the support for a first gas diffusion layer; 3) forming a first catalyst layer on one surface of a polymer electrolyte membrane; 4) forming a second catalyst layer on the other surface of the polymer electrolyte membrane; 5) forming the first gas diffusion layer on the first catalyst layer; and 6) forming a second gas diffusion layer on the second catalyst layer.

In describing each of the methods for manufacturing a membrane electrode assembly according to the present invention, since the support for a gas diffusion layer, the active metal particles, the sacrificial metal particles, and the like are identical or similar to the above descriptions for the membrane electrode assembly, the method for manufacturing a membrane electrode assembly according to the present invention includes all of the above descriptions for the membrane electrode assembly.

Hereinafter, the method for manufacturing a membrane electrode assembly of the present invention will be described in more detail.

FIG. 3 is a drawing showing a schematic diagram of a process of manufacturing a first gas diffusion layer in which the sacrificial metal particles are supported on a support for the first gas diffusion layer. Referring to FIG. 3, the method for manufacturing a membrane electrode assembly according to the present invention will be described, but this is for helping understanding of the present invention and the method for manufacturing a membrane electrode assembly according to the present invention is not interpreted as being limited by the drawings.

According to the method for manufacturing a membrane electrode assembly according to the present invention, the method for manufacturing a membrane electrode assembly may produce a membrane electrode assembly having high durability which may effectively suppress degradation of an active metal in a simple manner.

According to an exemplary embodiment, the sacrificial metal precursor in step 1) may be a chloride, an iodide, a sulfide, a fluoride, a hydroxide, a carbonate, and/or a nitrate including a metal having a lower standard reduction potential than an active metal included in the active metal particles. As a non-limiting example, the sacrificial metal precursor may be a nitrate including a metal having a lower standard reduction potential than an active metal included in the active metal particles, specifically silver nitrate (AgNO₃).

According to an exemplary embodiment, step 1) may be doping a solution including the sacrificial metal precursor on the support for the first gas diffusion layer, in which a solvent used herein may be one or more solvents selected from the group consisting of water, isopropanol, toluene, ethanol, n-propanol, n-butylacetate, ethylene glycol, butyl carbitol, and butyl carbitol acetate, but the present invention is not limited to the solvents, and an appropriate solvent may be selected depending on a chemical species of the sacrificial metal precursor.

According to an exemplary embodiment, step 2) may be performed by immersing the support for the first gas diffusion layer doped with the sacrificial metal precursor in a solution including a reducing agent. The solvent used herein may be the same as those described in step 1).

According to an exemplary embodiment, the reducing agent may be one or more reducing agents selected from the group consisting of sodium hydride (NaH), sodium borohydride (NaBH₄), lithium tetrahydroaluminate (LiAlH₄), hydrizine (N₂H₄), diisobutylaluminum hydride (DIBALH), and potassium triethyl borohydride (KEt₃BH).

According to an exemplary embodiment, steps 3) and 4) may use a method which is used in a layer or lamination of a thin film and is widely known in the art. As a non-limiting example, a slurry for forming a catalyst layer including the active metal particles is applied to each surface of the polymer electrolyte membrane and then dried, thereby forming the first catalyst layer and the second catalyst layer.

According to an exemplary embodiment, steps 5) and 6) may use a method which is used in a layer or lamination of a thin film and is widely known in the art. As a non-limiting example, the first gas diffusion layer and the second gas diffusion layer may be formed by assembling them on the first catalyst layer and the second catalyst layer without hot pressing, respectively.

According to an exemplary embodiment, the polymer electrolyte membrane may be applied without limitation as long as it is a polymer material which is applied to fuel cell fields and is known in the art. As a non-limiting example, the polymer electrolyte membrane may be a polymer to which one or more functional groups selected from the group consisting of sulfonated benzimidazole-based, sulfonated polyimide-based, sulfonated polyetherimide-based, sulfonated polyphenylene sulfide-based, sulfonated polysulfone-based, sulfonated polyether-based, sulfonated polyetherketone-based, sulfonated polyether-etherketone-based, sulfonated polyethersulfone-based, sulfonated polyphenylquinoxaline-based, and sulfonated partial fluorine-based groups are introduced, but the present invention is not limited thereto.

Hereinafter, the examples and the experimental examples will be illustrated specifically in detail. However, the examples and the experimental examples described later are only illustrative of some, and the technology described in the present specification is not construed as being limited thereto.

### (Example 1) Manufacture of Composite 1

100 mg of commercially available Pt/C (19.4 wt % of Pt, Tanaka Holdings Co., Ltd.) was sonicated in 100 ml of a 50% isopropanol (IPA) solution to prepare a dispersion. 0.1 ml of a AgNO₃ solution (10 mg_{Ag+}/ml) was added to the dispersion, and stirring was performed for 10 minutes to prepare a reaction solution. 1 ml of a NaBH₄ solution (50 mg/ml) was added to the prepared reaction solution, and a reduction reaction was performed for 1 hour. A solution after the reaction was completed was washed with deionized water, and dried overnight in an oven to manufacture Composite 1 (or Ag1+Pt/C) in which platinum (Pt) particles and silver (Ag) particles were supported on a carbon support. As a result of analysis by inductively coupled plasma-optical emission spectroscopy (ICP-OES), an atomic ratio between silver and platinum included in Composite 1 was 1:12.7.

### (Example 2) Manufacture of Composite 2

Composite 2 (or Ag3+Pt/C) was manufactured in the same manner as in Example 1, except that 0.3 ml of AgNO₃ solution was used, and as a result of ICP-OES analysis, an atomic ratio between silver and platinum included in Composite 2 was 1:4.41.

### (Example 3) Manufacture of Composite 3

Composite 3 (or Ag5+Pt/C) was manufactured in the same manner as in Example 1, except that 0.5 ml of AgNO₃ solution was used, and as a result of ICP-OES analysis, an atomic ratio between silver and platinum included in Composite 3 was 1:2.21.

### (Example 4) Manufacture of Gas Diffusion Layer on which Sacrificial Metal was Supported

A commercial gas diffusion carbon film (gas diffusion carbon layer, Sigracet 39 BC) having an area of 5 cm² was used as a support for a gas diffusion layer. The support for a gas diffusion layer was washed with acetone and dried on a hot plate at 60° C. Isopropanol (IPA) and deionized water mixed at a volume ratio of 1:1 were used as a solvent to prepare a AgNO₃ solution of 2 mg_{Ag+}/ml. 2.5 ml of the AgNO₃ solution was dropped on the washed and dried support for a gas diffusion layer, a support for a gas diffusion layer loaded with a silver (Ag) ion was immersed in a 10 mM NaBH₄ solution for 10 minutes to reduce the silver (Ag) ion into metallic silver (Ag), and drying was performed on a hot plate at 60° C. After completely drying, isopropanol (IPA) and deionized water mixed at a volume ratio of 1:1 were used to wash the NaBH₄-treated support for a gas diffusion layer, and drying was performed overnight in an oven at 60° C. to manufacture a gas diffusion layer in which silver (Ag) particles are supported on the support.

As a result of analysis by inductively coupled plasma-optical emission spectroscopy (ICP-OES, iCAP PRO ICP-OES, Thermo Fisher), a loading amount of silver (Ag) supported on the support was 1 mg/cm².

### (Example 5) Manufacture of Membrane Electrode Assembly

A membrane electrode assembly (MEA) was manufactured by spray coating both surfaces of Nafion N211 film (area of 5 cm²) with a catalyst slurry and drying the film on a hot plate at 60° C. to form an anode catalyst layer and a cathode catalyst layer, respectively, and then assembling the gas diffusion layer manufactured in Example 4 on each of the catalyst layers without hot pressing. The catalyst slurry was formed of commercial Pt/C (19.4 wt % of Pt, Tanaka Holdings Co., Ltd), deionized water, IPA, and 5 wt % of a Nafion solution. The catalyst loading amount was 0.05 mg_{Pt}/cm² for both the anode and the cathode.

### (Comparative Example 1) Commercial Pt/C

Commercial Pt/C (19.4 wt % of Pt, Tanaka Holdings Co., Ltd) was used to perform the experimental example.

### (Comparative Example 2) Manufacture of Pt₃Ag/C

80 mg of commercial carbon (Ketjen black EC600JD) was sonicated for 1 hour in 50 ml of deionized water to prepare a dispersion. Next, 0.168 ml of a H₂PtCl₆ solution (100 mg_{Pt4+}/ml) and 0.32 ml of a AgNO₃ solution (10 mg_{Ag+}/ml) were added to the prepared dispersion, and stirring was performed for 30 minutes to prepare a reaction solution. 2 ml of a NaBH₄ solution (50 mg/ml) was added to the prepared reaction solution, and a stirring was performed for 12 hours. Finally, the solution was filtered with deionized water to manufacture Pt₃Ag/C in which platinum and silver are supported on the carbon support in an alloy form. As a result of ICP-OES, an atomic ratio between silver and platinum included in Pt₃Ag/C was 1:3.67.

### (Comparative Example 3) Manufacture of Ag/C

Ag/C was manufactured in the same manner as in Example 2, except that commercial carbon (Ketjen black EC600JD) was used instead of commercial Pt/C.

### (Comparative Example 4) Manufacture of Gas Diffusion Layer on which Sacrificial Metal was not Supported

A commercial gas diffusion carbon layer (Gas diffusion carbon layer, Sigracet 39 BC) having an area of 5 cm² was used as the gas diffusion layer to perform the experimental example.

### (Comparative Example 5) Manufacture of Membrane Electrode Assembly on which Sacrificial Metal was not Supported

A membrane electrode assembly was manufactured in the same manner as in Example 5, except that the gas diffusion layer of Comparative Example 4 was used instead of the gas diffusion layer manufactured in Example 4.

### (Experimental Example 1) Analysis of Chemical Properties

It was confirmed that an alloy of platinum and silver included in the composite of the example was not formed by analysis of chemical properties. Specifically, X-ray diffraction (XRD, Rigaku Smartlab, 40 kV, 15 mA, 4° min⁻¹, Cu-Kα radiation, Δ=1.55406 Å), X-ray photoelectron spectroscopy (XPS, Kratos, AXIS-NOVA, 2.6×10⁻⁹ torr), high angle scattering dark field scanning transmission electron microscope (HAADF-STEM, FEI Themis Z), and energy dispersive X-ray spectroscopy (EDS, FEI Themis Z) were used.

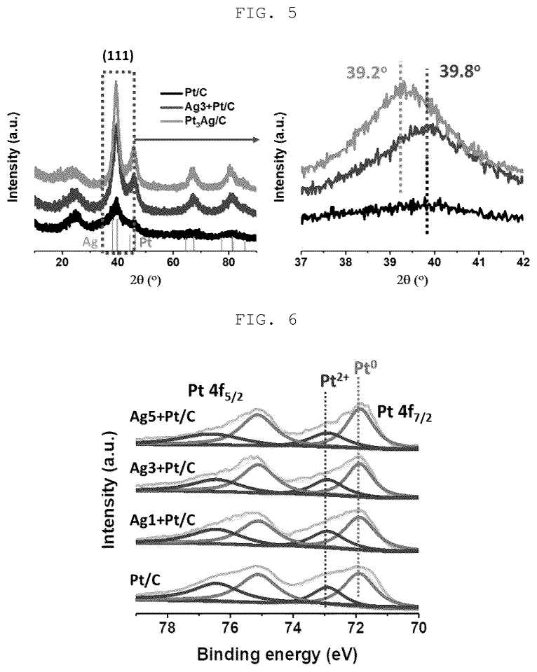

FIG. 4 is a drawing showing XRD patterns of Comparative Example 1 and Examples 1 to 3. FIG. 5 is a drawing showing XRD patterns of Comparative Examples 1 and 2 and Example 2. Referring to them, it was found that Comparative Example 1 and Examples 1 to 3 commonly had main peaks at 39.8° corresponding to (111) face centered cubic (fcc) Pt (JCPDS no. 04-0802). That is, the composites according to the examples had peaks at the same position as Pt/C, which shows that platinum and silver included in the composite did not alloyed. However, Comparative Example 2 having an alloy form had a peak at 39.2°, and it was found that the peak shifted by 0.6° when Example 2 and Comparative Example 1 were compared.

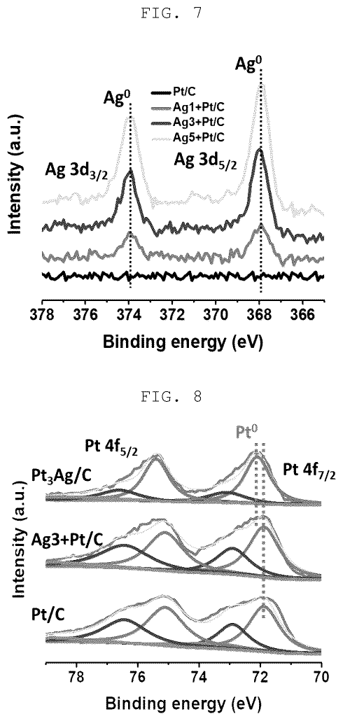

Meanwhile, referring to FIG. 4, the peak intensity on the (111) face of the examples was increased as compared with the comparative example, which shows that the peak on the (111) face overlapped a certain peak of Ag (JCPDS No. 04-0783, fcc Ag) added in the examples and was due to an increase in a metallic Pt component as shown in FIG. 6.

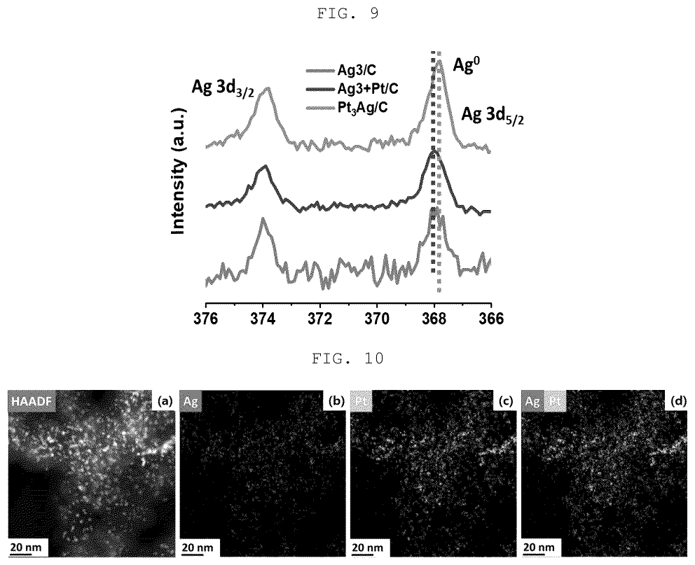

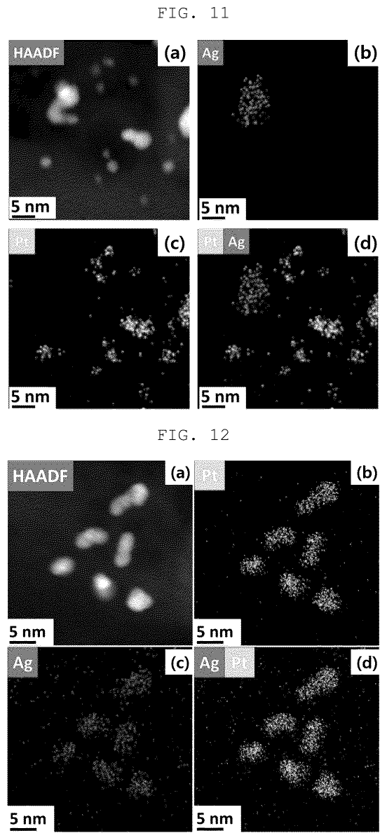

FIG. 6 is a drawing showing Pt 4f XPS spectra of Comparative Example 1 and Examples 1 to 3. FIG. 7 is a drawing showing Ag 3d XPS spectra of Comparative Example 1 and Examples 1 to 3. FIG. 8 is a drawing showing Pt 4f XPS spectra of Comparative Examples 1 and 2 and Example 2. FIG. 9 is a drawing showing Ag 3d XPS spectra of Comparative Examples 2 and 3 and Example 2.

Referring to FIG. 6, Comparative Example 1 and Examples 1 to 3 had the same Pt peak position (˜71.9 eV in the case of Pt⁰ at Pt 4f_{7/2}, ˜72.9 eV in the case of Pt²⁺). Referring to FIG. 7, Examples 1 to 3 mainly had a metallic Ag signal (˜368.0 eV in the case of Ag⁰ at Ag 3d_{5/2}), and as a Ag concentration increased, a signal intensity increased without signal position shift. Thus, it was found that the composite according to the examples did not form an alloy. However, referring to FIGS. 8 and 9, Comparative Example 2 showed a little higher binding energy in a 4f XPS spectrum than Example 2 and Comparative Example 1, while showing a lower binding energy in a Ag 3d XPS spectrum in Example 2 and Comparative Example 3. That is, the electron structure of Comparative Example 2 was changed due to an interaction between Pt and Ag.

Meanwhile, referring to FIG. 6, a ratio (I₀/I_{II}) between a Pt (0) peak intensity (I₀) and a Pt(II) peak intensity (I_{II}) in a Pt 4f_{7/2} XPS spectrum by X-ray photoelectron spectroscopy (XPS) was 1.76 in Comparative Example 1, 1.88 in Example 1, 2.38 in Example 2, and 2.85 in Example 3. That is, as a Ag content included in the composite increased, the peak intensity of metallic Pt⁰ tended to increase, but the peak intensity of Pt²⁺ tended to decrease. This is considered to be due to the reduction from Pt²⁺ to Pt⁰, and was consistent with the XRD spectrum results of FIG. 4.

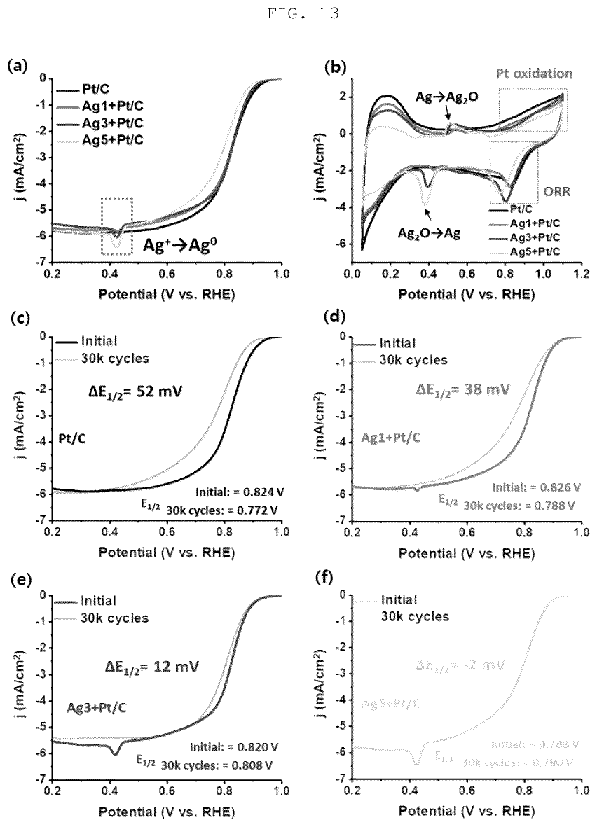

FIG. 10 is HAADF-STEM images of Example 2 and a corresponding EDS mapping image, and FIG. 11 is enlarged images thereof. FIG. 12 is HAADF-STEM images of Comparative Example 2 and a corresponding EDS mapping image. Referring to them, in Comparative Example 2, formation of an alloy was clearly confirmed, but in Example 2, platinum (Pt) particles and silver (Ag) particles were all uniformly distributed on the carbon support, and were independently distributed without interaction between the platinum (Pt) particles and the silver (Ag) particles.

### (Experimental Example 2) Analysis of Electrochemical Properties

The electrochemical performance for an oxygen reduction reaction was evaluated as VSP potentiostat (Bio-Logic SAS) having a standard 3-electrode cell in 0.1 M HClO₄. As a reference electrode, a counter electrode, and a working electrode, a KCl-saturated Ag/AgCl electrode, a Pt wire, and a rotating disk electrode (RDE, diameter: 3 mm, area: 0.07065 cm²) were used, respectively. At this time, 2.5 mg of powders each of which was prepared according to Comparative Example 1, Comparative Example 2, and Examples 1 to 3 were sonicated for 30 minutes in a mixed slurry in which 4 ml of deionized water, 1 ml of IPA, and 0.4 ml of a 5 wt % Nafion solution were mixed to perform dispersion, thereby preparing a uniform slurry, and then RDE was coated with the uniform slurry to manufacture a working electrode loaded with 50 μg/cm² of Pt.

The electrode was stabilized by cyclic voltammetry (CV) of 30 cycles at a scan rate of 50 mV/s in a scan range of 0.05 V to 1.15 V in a nitrogen-saturated 0.1 M HClO₄ solution before electrochemical performance evaluation. Linear sweep voltammetry (LSV) was performed at a scan rate of 10 mV/s in an oxygen or nitrogen-saturated 0.1 M HClO₄ solution, and a final polarization curve was obtained as a value obtained by subtracting current density in nitrogen from current density in oxygen. CV was performed at a scan rate of 50 mV/s in a scan range of 0.05 V to 1.15 V in an oxygen or nitrogen-saturated 0.1 M HClO₄ solution.

The accelerated durability test (ADT) was performed by performing CV at a scan rate of 100 mV/s in a scan range of 0.60 V to 0.95 V in a nitrogen-saturated 0.1 M HClO₄ solution for 30,000 (30 k) cycles. After completing ADT, LSV was performed under the same initial measurement conditions.

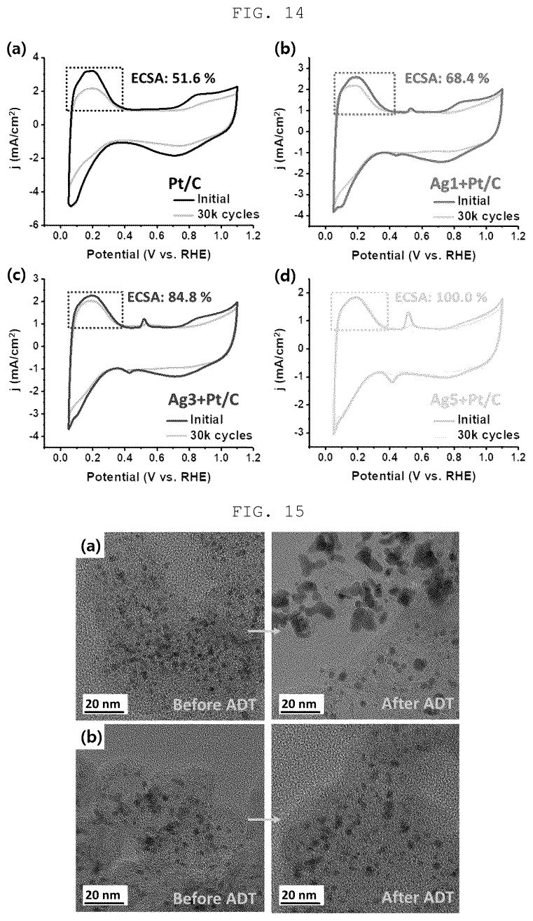

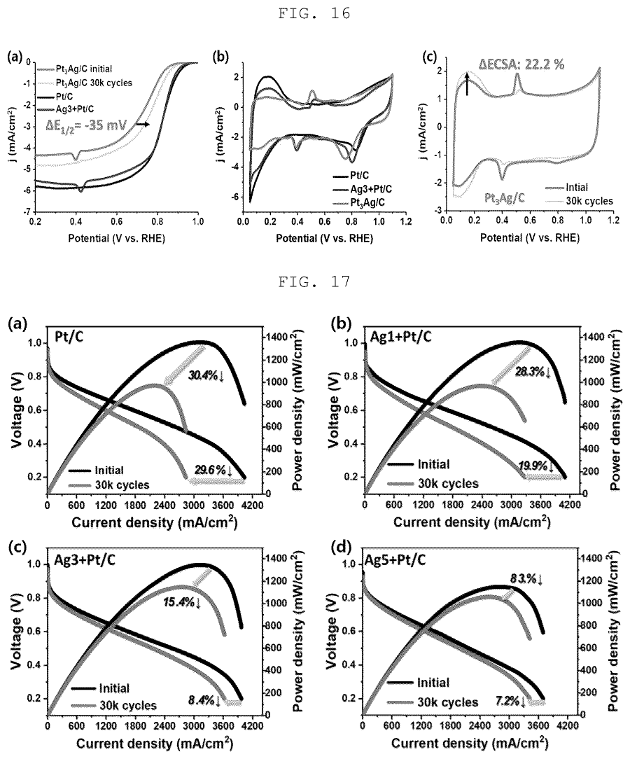

FIG. 13 is drawings showing results of evaluating electrochemical performance of Comparative Example 1 and Examples 1 to 3. Specifically, in FIG. 13, (a) and (b) are drawings showing LSV curves and CV curves, (c) to (f) are drawings showing LSV curves before and after ADT of each of Comparative Example 1 and Examples 1 to 3. FIG. 14 is drawings showing CV curves before and after ADT of each of Comparative Example 1 and Examples 1 to 3. FIG. 15 is transmission electron microscope (TEM, FEI Tecnai G2 twin) images before and after ADT of each of Comparative Example 1 and Example 2. FIG. 16 is drawings showing results of evaluating electrochemical performance of Comparative Example 2 in an alloy form. Specifically, in FIG. 16, (a) shows LSV curves before and after ADT, (b) shows CV curves of Comparative Example 1, Comparative Example 2, and Example 2, and (c) shows CV curves before and after ADT of Comparative Example 2.

Referring to (a) of FIG. 13, Examples 1 and 2 showed onset and half-wave (E_{1/2}) potentials similar to Comparative Example 1, but Example 3 showed a little lower performance. This is considered to be due to the fact that in Example 3, as a silver (Ag) loading amount was increased, aggregated silver nanoparticles blocked the catalytic active site of platinum.

Referring to (b) of FIG. 13, Examples 1 to 3 showed a pair of silver (Ag) reduction and oxidation peaks in ˜0.4 V and ˜0.55 V. The maximum value of the redox peaks tended to shift to a lower potential as a silver (Ag) loading amount increased. As the silver (Ag) loading amount increased, an exposed surface area of silver (Ag) was increased, and thus, more redox reaction sites were provided, so that the overvoltage to the redox reaction was lowered. However, oxidation of platinum (Pt) shifted to a higher potential as the silver (Ag) loading amount increased. Specifically, it was shown as 0.733 V in Comparative Example 1, 0.745 V in Example 1, 0.781 V in Example 2, and 0.797 V in Example 3. Thus, it was found that the composite according to the examples may suppress oxidation of platinum (Pt) by including silver (Ag) particles.

Referring to (c) to (f) of FIG. 13, it was found that the half-wave potential was decreased by 52 mV in Comparative Example 1, while decreased by 38 mV in Example 1 and decreased by 12 mV in Example 2, and in particular, in Example 3, the initial half-wave potential of 0.790 V was maintained without substantial change during ADT. In addition, referring to FIG. 14, change in electrochemical active surface area (ECSA) by dissolution and aggregation of platinum caused by oxidation of platinum (Pt) during ADT may be determined. The retention rate of ECSA was high as the silver (Ag) loading amount increased. Specifically, it was shown as 51.6% in Comparative Example 1, 68.4% in Example 1, 84.8% in Example 2, and 100% in Example 3. In addition, referring to FIG. 15, in Comparative Example 1, the size of platinum (Pt) particles was increased by 2 to 4 times, but in Example 2, it was confirmed that the particle size distribution (2 to 4 nm) before and after ADT was maintained. However, referring to FIG. 16, in Comparative Example 2 in an alloy form, a half-wave potential and ECSA were increased as silver (Ag) particles which covered the catalyst reaction site of platinum were dissolved after ADT, but the value was significantly lower than those of Example 2 and Comparative Example 1, and thus, it was found that the ORR catalytic activity was decreased.

In summary, since the composites according to the examples included the sacrificial metal particles which may suppress oxidation of the active metal in a state of not forming an alloy with the active metal, it was found that ORR catalytic activity was excellent.

### (Experimental Example 3) Analysis of Characteristics of Fuel Cell Including Composite

For a performance test of a proton exchange membrane fuel cell (PEMFC), a membrane electrode assembly (MEA) was manufactured by a catalyst-coated membrane (CCM) having an active area of 5 cm². As an anode catalyst, commercial Pt/C (19.4 wt % of Pt, Tanaka Holdings Co., Ltd.) was used. As a cathode catalyst, the composite manufactured in the examples or the comparative examples was used. CCM was manufactured by mixing each catalyst with deionized water, IPA, and 5 wt % of a Nafion solution to prepare a slurry, spray-coating the prepared slurry on a Nafion N211 film, and drying it on a hot plate at 60° C. for several hours. A catalyst loading amount was 0.05 mg_{Pt}/cm² in both the cathode and the anode. Thereafter, the membrane electrode assembly was assembled with a commercial gas diffusion layer (GDL, SGL 39 BC) without hot pressing.

A proton exchange membrane fuel cell was operated at 80° C. under 0.5 bar of a back pressure under constant current conditions by supplying pure hydrogen at a relative humidity of 100% to the anode at a flow rate of 300 sccm and supplying pure oxygen at a relative humidity of 100% to the cathode at a flow rate of 1000 sccm. Electrochemical impedance spectroscopy (EIS) was performed at 5 kHz to 100 mHz at a cell current of 100 mA/cm².

In order to evaluate the durability of the catalyst, the accelerated durability test (ADT) was performed based on the CV cycles of 30 k proposed by the U.S. Department of Energy (DOE). According to the electrocatalyst cycle protocols, it was performed between 0.6 V and 0.95 V for a hold time of 3 seconds in positive potential while supplying pure hydrogen at a relative humidity of 100% to the anode at a flow rate of 100 sccm and supplying pure nitrogen at a relative humidity of 100% to the cathode at a flow rate of 50 sccm at 80° C. under ambient pressure. A rise time between positive potentials was set to 0.5 seconds.

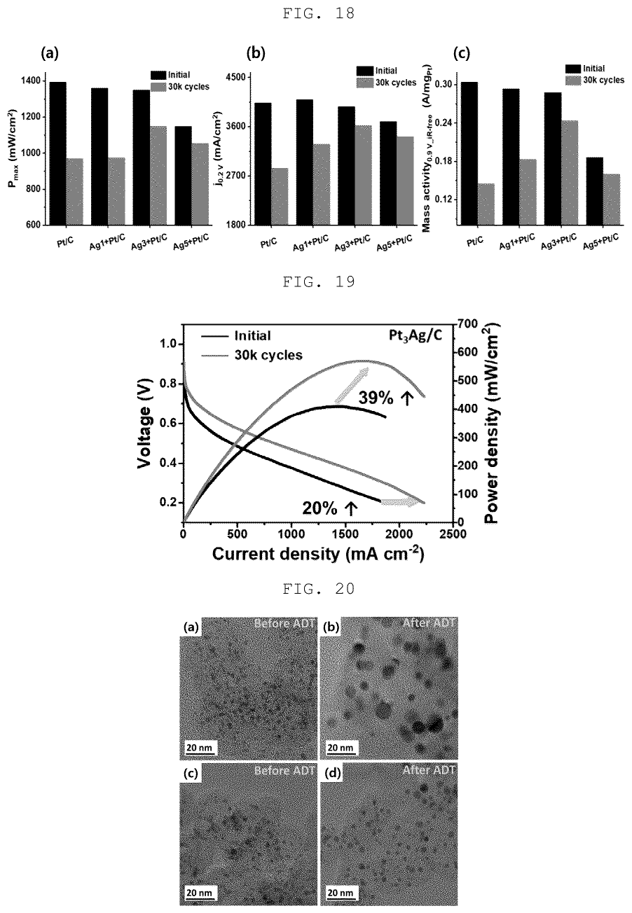

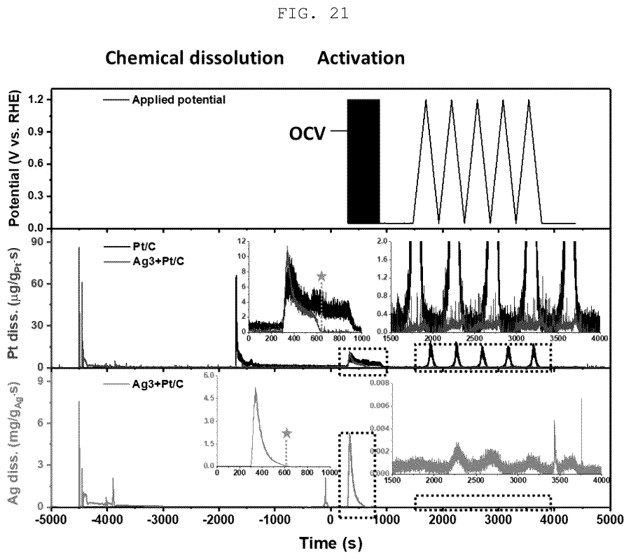

FIGS. 17 and 18 are drawings showing performance before and after ADT performed for 30 k cycles of a fuel cell to which each of Comparative Example 1 and Examples 1 to 3 was applied as a cathode catalyst. Specifically, FIG. 17 is drawings showing polarization curves and power density curves of fuel cells to which Comparative Example 1 (a), Example 1 (b), Example 2 (c), and Example 3 (d) were applied. FIG. 18 is drawings showing a maximum power density (Pₘₐₓ) before and after ADT (a), current density at 0.2 V (j_{0.2V}) before and after ADT (b), and mass activity at 0.9 V having no iR before and after ADT (c). FIG. 19 is a drawing showing polarization curves and power density curves before and after ADT of a fuel cell to which Comparative Example 2 in an alloy form was applied as a cathode catalyst. FIG. 20 is drawings showing a change in size of particles before and after ADT in fuel cells of Comparative Example 1 and Example 2. Specifically, in FIG. 20. (A) and (b) are TEM images before and after ADT in the fuel cell of Comparative Example 1, respectively, and (c) and (d) are TEM images before and after ADT in the fuel cell of Example 2, respectively.

Referring to FIGS. 17 and 18, it was found that all of the fuel cells to which Examples 1 to 3 were applied had better durability than the fuel cell of Comparative Example 1, and as the silver (Ag) loading amount increased, differences in the maximum power density, current density, and mass activity depending on ADT of 30 k cycles were decreased, and thus, durability tended to increase. However, referring to FIG. 19, the fuel cell to which Comparative Example 2 was applied had increased maximum power density and current density after ADT, but since the values were significantly lower than those of Examples 1 to 3, it was found that the fuel cell of Comparative Example 2 had lowered ORR catalytic activity. Referring to FIG. 20, it was confirmed that the average particle diameter of platinum (Pt) particles was increased from 2.5 nm to 4 nm during ADT in Example 2, but was increased from 2.5 nm to 10 nm in Comparative Example 1.

In summary, since the composite according to the example included the sacrificial metal particles in a state of not forming an alloy with the active metal, it was found that its initial ORR catalytic activity was maintained or decreased with a low decrease rate even after harsh ADT, and thus, its durability was excellent.

### (Experimental Example 4) Analysis of Metal Dissolution

For analysis of dissolution of platinum and silver, an in-situ inductively coupled plasma mass analyzer (ICP-MS, iCAP RQ, Thermo-Fisher Science) was used.

Specifically, an electrochemical flow cell (EFC) directly manufactured by ICP-MS was combined. EFC was made up of a U-shaped channel having an opening diameter of 3 mm for connection with a working electrode (A-002012, Bio-Logic), and a graphite counter electrode and a Ag/AgCl reference electrode were connected to an opening and an outlet of EFC, respectively. The working electrode was manufactured by drop casting a catalyst ink on glassy carbon (0.07065 cm²) so that 10 μg/cm² of the metal was loaded. The catalyst ink for ICP-MS study was manufactured by dispersing 5 mg of a catalyst in an aqueous solution including 1179 μl of deionized water, 50 μl of Nafion, and 186 μl of IPA. A 0.1 M HClO₄ electrolyte solution saturated with argon was mixed with an internal standard solution including 5 ppb of ¹⁸⁷Re and 0.5 M HNO₃, and then the mixture was added to ICP-MS. The dissolution characteristics of platinum and silver were estimated quantitatively by measured ¹⁹⁵Pt and ¹⁰⁷Ag signals compared to ¹⁸⁷Re.

An electrochemical protocol for an on-line ICP-MS experiment includes a chemical dissolution step, an activation step, and a slow scan step, sequentially. In the chemical dissolution step, potential was not applied, the activation step included CV at a high scan speed (200 mV·s) of 50 cycles, and the slow scan step included CV at a slow scan speed (5 mV/s) of 5 cycles at 0.05 to 1.2 V_{RHE}. The ICP-MS signal was stabilized while maintaining potential at 0.05 V_{RHE} between the activation step and the slow scan step.

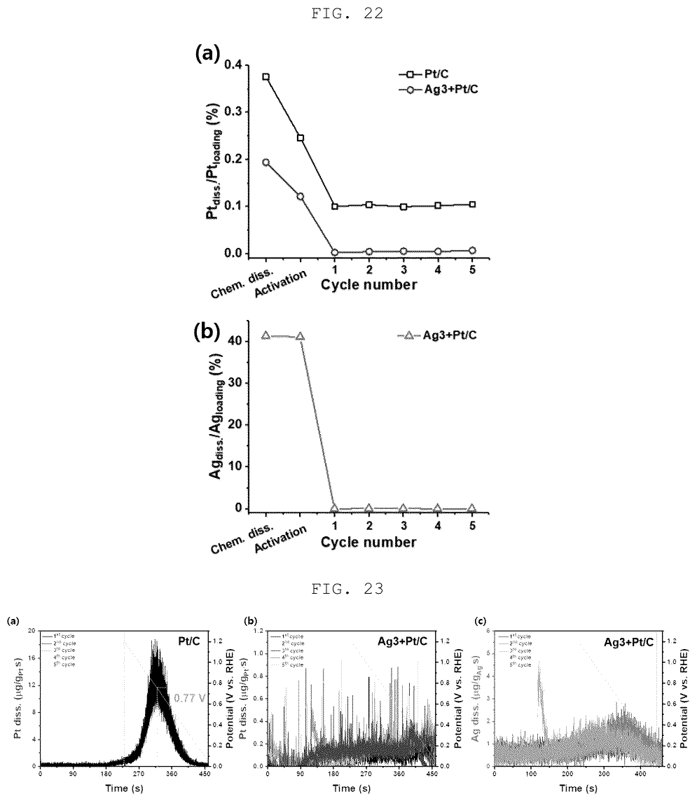

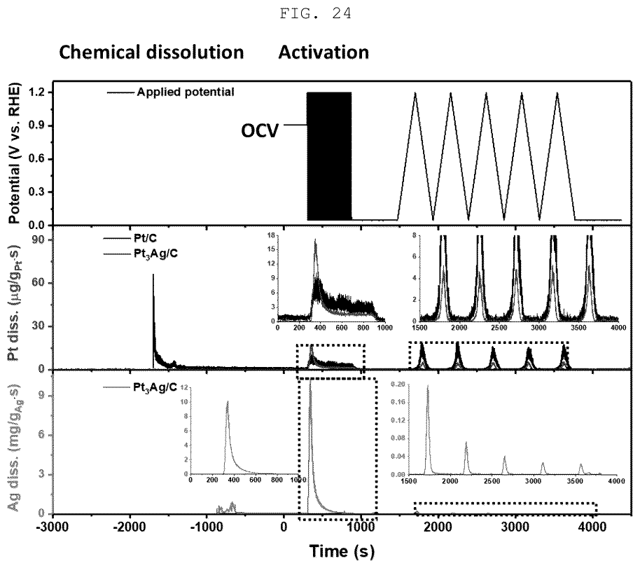

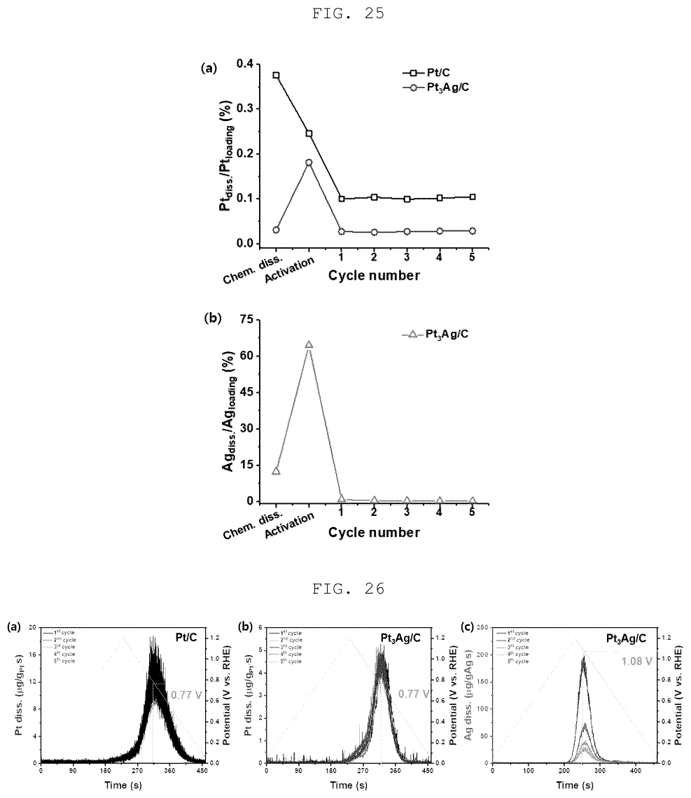

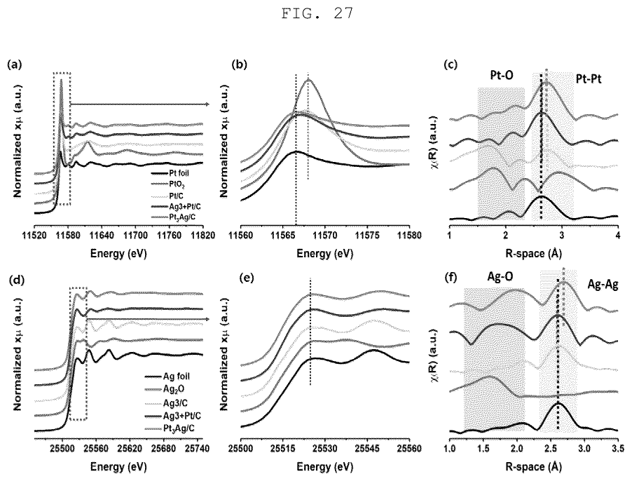

FIGS. 21 to 23 are drawings showing results of an on-line ICP-MS experiment performed for Comparative Example 1 and Example 2. Specifically, FIG. 21 is a drawing showing the dissolution profiles of platinum and silver according to each treatment condition. In FIG. 22, (a) and (b) are drawings showing the dissolution rates of platinum and silver to the amount loaded onto the working electrode, respectively. FIG. 23 is a drawing showing the dissolution profile according to each cycle proceeding at a slow scan speed (5 mV/s). FIGS. 24 to 26 are drawings showing results of an on-line ICP-MS experiment performed in the same manner for Comparative Examples 1 and 2.

First, after chemically unstable platinum was leached out by an acidic electrolyte in the chemical dissolution step, it was oxidized without participating in the reduction reaction so that the chemically stable platinum was dissolved. Referring to FIGS. 21 and 22, the dissolution rate of platinum was 0.38% and 0.25% in the chemical dissolution step and the activation step, respectively, in Comparative Example 1, but was 0.19% and 0.12%, respectively in Example 2, and thus, the composite of Example 2 had more improved stability. In the slow scan step, the platinum dissolution rate per each cycle was 0.10% in Comparative Example 1, but was 0.0043%, which is 23 times less, in Example 2, and thus, it was found that the composite of Example 2 had significantly improved stability since platinum was hardly dissolved.

Upon review of the activation step in detail through the drawing of FIG. 21, it was found that the dissolution behaviors of platinum were similar in the section of 300 to 600 seconds in both Comparative Example 1 and Example 2, and silver of Example 2 was also dissolved in the same section. However, in Example 2, it was found that dissolution of platinum and silver hardly occurred after 600 seconds, unlike Comparative Example 1.

Referring to FIG. 23, the average dissolution rate of platinum was 12 μg/g_{Pt}·s (3.7×10¹⁶ atom_{Pt}/g_{Pt}·s) in Comparative Example 1, but was 0.15 μg/g_{Pt}·s (4.6×10¹⁴ atom_{Pt}/g_{Pt}·s) in Example 2, at 0.77 V, and thus, there was a difference of about 80 times. Meanwhile, the average dissolution rate of silver was an average dissolution rate of 1.4 μg/g_{Ag}·s (7.8×10¹⁶ atom_{Ag}/g_{Ag}·s) in Example 2.

Referring to FIGS. 24 to 26, in Comparative Example 2, in the chemical dissolution step and the activation step, the dissolution rate of platinum was 0.03% and 0.18%, respectively, the dissolution rate of silver was 12.26% and 64.43%, respectively, the average dissolution rate of platinum was 4.2 μg/g_{Pt}·s at 0.77 V, and the average dissolution rate of silver was 66.8 μg/g_{Ag}·s at 1.08 V, in each cycle of the slow speed step. That is, in Comparative Example 2 in an alloy form, platinum dissolution was suppressed as compared with Comparative Example 1, but was not effectively suppressed as compared with Example 2. Thus, it was found that an alloy form was not stable under repeated electrochemical oxidation and reduction potential, and silver (Ag) included in the composite in an alloy form did not perform the function of the sacrificial metal well as compared with silver (Ag) included in the composite according to an exemplary embodiment which is not in an alloy form.

In summary, it is assumed that the composite according to an exemplary embodiment changed to a structure having high resistance to an electrochemical oxidation reaction after an excessive amount (40% as compared with an initial loading amount) of silver was dissolved in the chemical dissolution and the activation steps.

### (Experimental Example 5) Analysis of Chemical Structure and Electronic Structure of Composite

Analysis of the chemical structure and the electronic structure was performed by X-ray absorption spectroscopy (XAS) including X-ray absorption near edge structure (XANES) and extended X-ray absorption fine structure (EXAFS) measurements.

An XAS spectrum was measured with a ring current of 250 mA at 3.0 Gev in a BL8C beam line of a Pohang light source (PLS-II). It was collected in both a transmission mode and a fluorescence mode, and the obtained spectrum was treated using a Demeter package.

In order to monochromate an X-ray beam, a Si (111) double crystal monochromator was used. Higher order harmonic contamination occurring in an XAS experiment was adjusted so that the intensity of projected X-ray was decreased by 30%.

In-situ XAS was performed by an electrochemical cell of a standard 3-electrode system. A Ag/AgCl electrode, a graphite rod, and carbon paper coated with the catalyst of the example or the comparative example were used as a reference electrode, a counter electrode, and a working electrode, respectively. A nitrogen-saturated 0.1 M HClO₄ was used as an electrolyte solution. For catalyst stabilization, 20 CV cycles were performed in a range of 0.05 V to 1.05 V before XAS measurement. Next, after stabilization for 30 minutes, XAS was analyzed in various potentials from an open circuit voltage (OCV) to 1.5 V with chronoamperometry. The XAS spectrum was collected by a silicon drift detector (SDD) in a fluorescence mode. The obtained spectrum was treated using the Demeter package. A Pt oxidation state was evaluated in a white line peak area of a normalized Pt L₃-edge XANES spectrum.

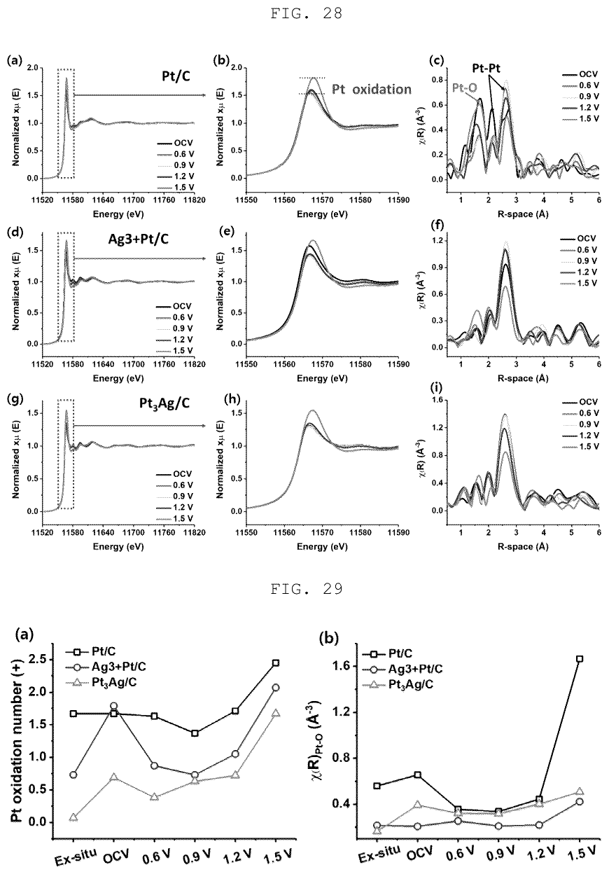

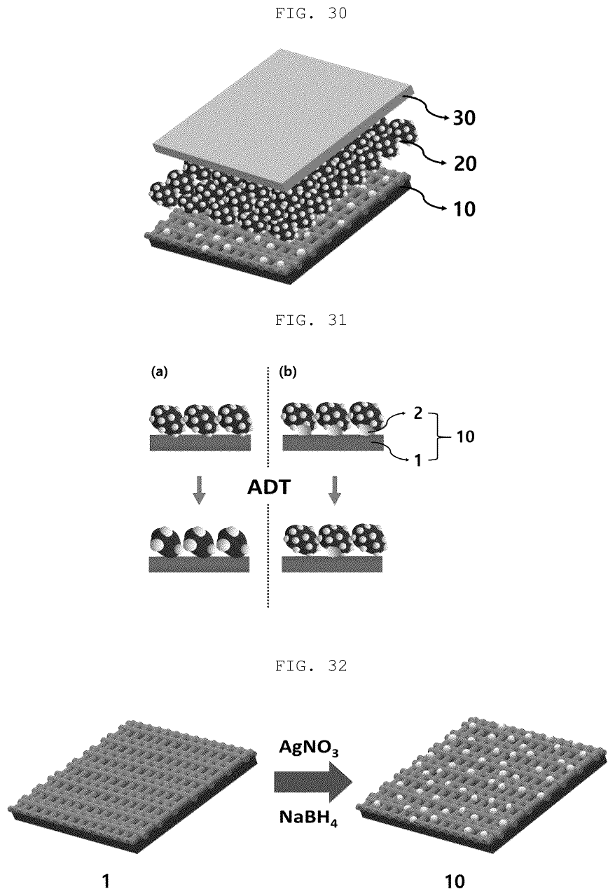

FIG. 27 is drawings showing Ex-situ XAS spectra of Pt L₃-edges (or Ag K-edges) for Comparative Example 1 (or Comparative Example 3), Comparative Example 2, Example 2, Pt foil (or Ag foil), and PtO₂ (or AgO₂). Specifically, in FIG. 27, (a) and (b) are Pt L₃-edge XANES spectra, (c) is Pt L₃-edge FT-EXAFS spectra, (d) and (e) are Ag K-edge XANES spectra, and (f) is Ag K-edge FT-EXAFS spectra. FIG. 28 is drawings showing In-situ XAS spectra of Pt L₃-edges for Comparative Example 1, Example 2, and Comparative Example 2. Specifically, in FIG. 28, (a), (d) and (g) are XANES spectra of Comparative Example 1, Example 2, and Comparative Example 2, respectively, (b), (e), and (h) are enlarged XANES spectra, respectively, and (c), (f), and (i) are FT-EXAFS spectra of Comparative Example 1, Example 2, and Comparative Example 2. FIG. 29 is drawings showing a platinum oxidation states depending on applied potentials of Comparative Example 1, Example 2, and Comparative Example 2. Specifically, it was derived from the data according to FIG. 28, and in FIG. 29, (a) is a drawing showing a change in the oxidation number of platinum and (b) is a drawing showing a Pt—O formation profile.

Referring to (a) and (b) of FIG. 27, the white line peak existed at 11568.0 eV which is at a similar peak position to PtO₂ in Comparative Example 1, at 11567.2 eV in Example 2, and at 11566.7 eV which is almost at the same peak position as a Pt foil. Thus, since the composite according to an exemplary embodiment included silver (Ag) particles, it was found that the oxidation state of platinum was low and the metallic platinum component was increased.

Referring to (c) of FIG. 27, Comparative Example 1 had Pt—O and Pt—Pt radial distances of 1.70 Å and 2.73 Å, Example 2 had a Pt—Pt radial distance of 2.65 Å similar to the Pt foil (2.64 Å), but Comparative Example 2 had a longer Pt—Pt radial distance of 2.72 Å by an alloying effect.

Referring to (d) and (e) of FIG. 27, since all samples had the white line peak at similar positions, it was found that they had similar Ag oxidation states. Referring to (f) of FIG. 27, Comparative Example 2 had a Ag—Ag radial distance of 2.70 Å which was shifted as compared with Example 2 (2.60 Å) and Comparative Example 3 (2.61 Å) likewise by the alloying effect.

Referring to (a) of FIG. 29. Example 2 had a similar Pt oxidation number to Comparative Example 1 in OCV, but a lower Pt oxidation number in a potential range of OCV or higher, and thus, it was found that the addition of silver (Ag) actually played a key role in suppressing oxidation of platinum (Pt). However, Comparative Example 2 showed a much lower platinum (Pt) oxidation state in an applied potential range, and also showed that alloyed silver (Ag) may also serve as a sacrificial material. However, in Comparative Example 2 in an alloy form, since silver (Ag) present on the surface partially covered the active site of platinum (Pt), lower ORR activity was shown as compared with the composite on which silver (Ag) particles were independently loaded.

Referring to (b) of FIG. 29, Comparative Example 1 showed much increased Pt—O interaction energy as compared with Example 2 or Comparative Example 2. Example 2 and Comparative Example 2 had much less Pt—O formation tendency due to the sacrificial role of silver which is oxidized before platinum. However, the dissolution of silver in Comparative Example 2 had lower silver binding energy and was much faster than Example 2, as seen in FIG. 9, and thus, it was confirmed that silver (Ag) particles supported independently of platinum (Pt) particles on the carbon support are more appropriate and efficient for suppressing oxidation and dissolution of platinum. As a result, in the composite according to an exemplary embodiment, since the active metal particles and the sacrificial metal particles were independently present, the sacrificial metal particles were able to perform the role as a sacrifice better and the oxidation problem of the active metal was able to be essentially solved.

### (Experimental Example 6) Analysis of Characteristics of Gas Diffusion Layer

In order to analyze the characteristics of the gas diffusion layer, a scanning electron microscope (SEM, Magellan400, FEI Company), energy dispersive X-ray spectroscopy (EDS, FEI Themis Z), X-ray diffraction (XRD, Rigaku Smartlab, 40 kV, 15 mA, 4° min⁻¹, Cu-Kα radiation, λ=1.55406 Å), and X-ray photoelectron spectroscopy (XPS, Kratos, AXIS-NOVA, 2.6×10⁻⁹ torr) were used.

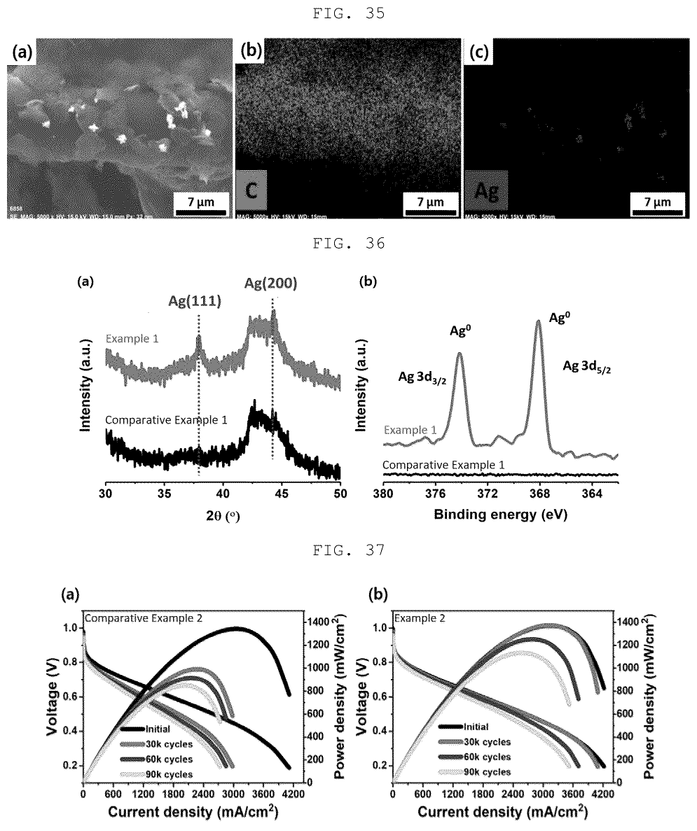

FIG. 33 is drawings showing scanning (SEM) images of the gas diffusion layers of Comparative Example 4 and Example 4. Specifically, in FIG. 33, (a) and (b) are images of the commercial gas diffusion layer of Comparative Example 4, and (c) and (d) are images of the gas diffusion layer manufactured in Example 4. FIG. 34 is drawings showing an SEM image of the gas diffusion layer of Comparative Example 4 and a corresponding EDS mapping image, and FIG. 35 is drawings showing an SEM image of the gas diffusion layer of Example 4 and a corresponding EDS mapping image. In FIG. 36, (a) is a drawing showing X-ray diffraction (XRD) patterns of the gas diffusion layers of Comparative Example 4 and Example 4, and (b) is a drawing showing Ag 3d XPS spectra of the gas diffusion layers of Comparative Example 4 and Example 4.

Referring to FIG. 33, in Comparative Example 4, a porous net structure in which randomly distributed carbon fiber was assembled was observed, and in Example 4, white particles formed on carbon fiber of a porous net structure were observed. Referring to FIGS. 34 and 35, in Example 4, it was found that silver (Ag) particles were randomly distributed on carbon fiber. Referring to (a) of FIG. 36, in Example 4, a peak) (38° on a (111) face and a peak) (44° on a (200) face which corresponds to a face centered cubic (fcc) silver (Ag) crystal structure were observed, unlike Comparative Example 4. Referring to (b) of FIG. 36, in Example 4, the peaks of Ag⁰ for Ag 3d_{3/2} and Ag 3d_{5/2} were observed at 374 eV and 368 eV, respectively, unlike Comparative Example 4. Thus, it was found that white particles observed in the gas diffusion layer of Example 4 were a silver (Ag) metal.

### (Experimental Example 7) Analysis of Characteristics of Fuel Cell Including Membrane Electrode Assembly

The membrane electrode assemblies manufactured in Example 5 and Comparative Example 5, respectively, were used to evaluate the performance of a proton exchange membrane fuel cell (PEMFC). Specifically, a proton exchange membrane fuel cell was operated at 80° C. under 0.5 bar of a back pressure under constant current conditions by supplying pure hydrogen at a relative humidity of 100% to the anode at a flow rate of 300 sccm and supplying pure oxygen at a relative humidity of 100% to the cathode at a flow rate of 1000 sccm.

In order to evaluate the durability of the catalyst, the accelerated durability test (ADT) based on the cyclic voltammetry (CV) cycles of 30,000 (30 k) as proposed by the U.S. Department of Energy (DOE) was performed, and recently, the ADT was performed by further extending to 90,000 (90 k) cycles as proposed in the Million Mile Fuel Cell Truck (M2FCT) protocol. According to the electrocatalyst ADT cycle protocols, it was performed between 0.6 V and 1.0 V for a hold time of 3 seconds in positive potential while supplying pure hydrogen at a relative humidity of 100% to the anode at a flow rate of 100 sccm and supplying pure nitrogen at a relative humidity of 100% to the cathode at a flow rate of 50 sccm at 80° C. under ambient pressure. A rise time between positive potentials was set to 0.5 seconds.

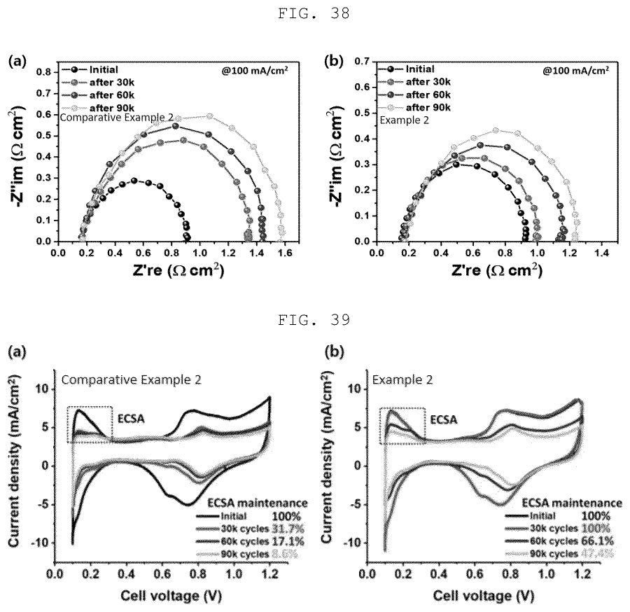

FIG. 37 is drawings showing polarization curves depending on the ADT cycles of the fuel cells to which Example 5 and Comparative Example 5 were applied. Specifically, the polarization curves were measured in the beginning before performing ADT, at the 30,000th (30 k) cycle, at the 50,000th (60 k) cycle, and at the 90,000th (90 k) cycle.

The values of the maximum power density (Pₘₐₓ), the current density at 0.2 V (j_{0.2V}), and the mass activity at 0.9 V (MA_{0.9V}) without iR, and the retention rate of each performance as compared with the initial values in Comparative Example 5 and Example 5 depending on each cycle are summarized in Table 1.

TABLE 1

| | | | Retention | | Retention | | Retention |
|---|---|---|---|---|---|---|---|
| | | Pmax | rate (%) | j_{0.2 V} | rate (%) | MA0.9 V | rate (%) |
| | Cycle | (mW/cm²) | of Pₘₐₓ | (mA/cm²) | of j0.2 V | (A/mg_{Pt}) | of MA_{0.9 V} |
| Comparative | 0 | 1395 | — | 4035 | — | 0.304 | — |
| Example 2 | 30 k | 970 | 69.5 | 2840 | 70.4 | 0.145 | 47.7 |
| | 60 k | 887 | 63.6 | 2749 | 68.1 | 0.133 | 43.8 |
| | 90 k | 824 | 59.1 | 2637 | 65.4 | 0.121 | 39.8 |
| Example 2 | 0 | 1375 | — | 4198 | — | 0.300 | — |
| | 30 k | 1373 | 99.9 | 4091 | 97.5 | 0.300 | 100.0 |
| | 60 k | 1250 | 90.9 | 3690 | 87.9 | 0.265 | 88.3 |
| | 90 k | 1135 | 82.5 | 3500 | 83.4 | 0.238 | 79.3 |

Referring to Table 1, it was found that there was no big difference between Comparative Example 5 and Example 5 before performing ADT. However, after performing ADT, the performance of the fuel cell of Comparative Example 5 was significantly deteriorated, but the performance of the fuel cell of Example 5 was maintained the same as in the beginning.

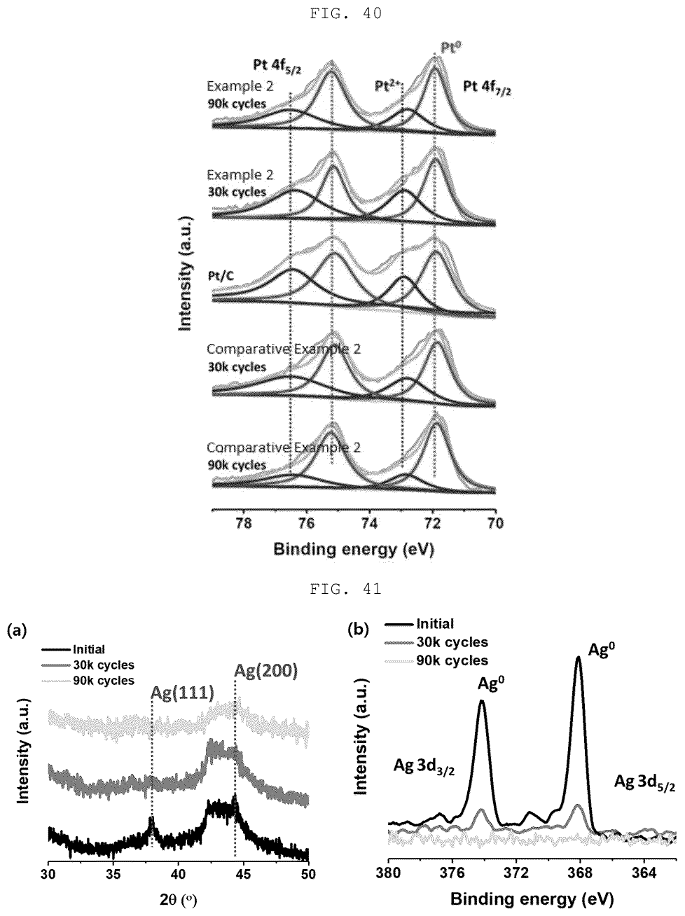

FIG. 38 is drawings showing results of electrochemical Impedance Spectroscopy (EIS) measurement depending on ADT cycles of fuel cells to which Example 5 and Comparative Example 5 were applied. At this time, the electrochemical impedance spectroscopy was performed at a cell current of 100 mA/cm². Referring to (a) of FIG. 38 showing the results of Comparative Example 5, it was increased from 0.912 Ω·cm² to 1.35 Ω·cm² after the 30, 000th (30 k) cycle and increased to 1.58 Ω·cm² after the 90, 000th (90 k) cycle. However, referring to (b) of FIG. 38 showing the results of Example 5, it was increased from 0.912 Ω·cm² to 1.00 Ω·cm² after the 30,000th (30 k) cycle and increased to 1.24 Ω·cm² after the 90,000th (90 k) cycle, and thus, it was found that transfer resistance was greatly decreased as compared with Comparative Example 5.

FIG. 39 is drawings showing CV curves depending on the ADT cycles of the fuel cells to which Example 5 and Comparative Example 5 were applied. Referring to FIG. 39, the electrochemical active surface area (ECSA) was maintained at only 31.7% and 8.6% of the initial value after the 30,000th (30 k) cycle and the 90,000th (90 k) cycle, respectively, in Comparative Example 5, but was maintained at 100% and 47.1% of the initial value in Example 5.

Thus, it was found that since the membrane electrode assembly of the present invention and the fuel cell including the same included the gas diffusion layer including the sacrificial metal particles, the durability of the catalyst was significantly improved. Specifically, the fuel cell has high retention rates of electrochemical active surface area, (ECSA), maximum current density, current density, and activity per unit mass (mass activity) even after the accelerated durability test (ADT) under harsh conditions, and may significantly reduce an increase in charge transfer resistance.

In order to describe the improvement of the performance as such, the cathode catalyst layer and the cathode gas diffusion layer after performing ADT were analyzed.

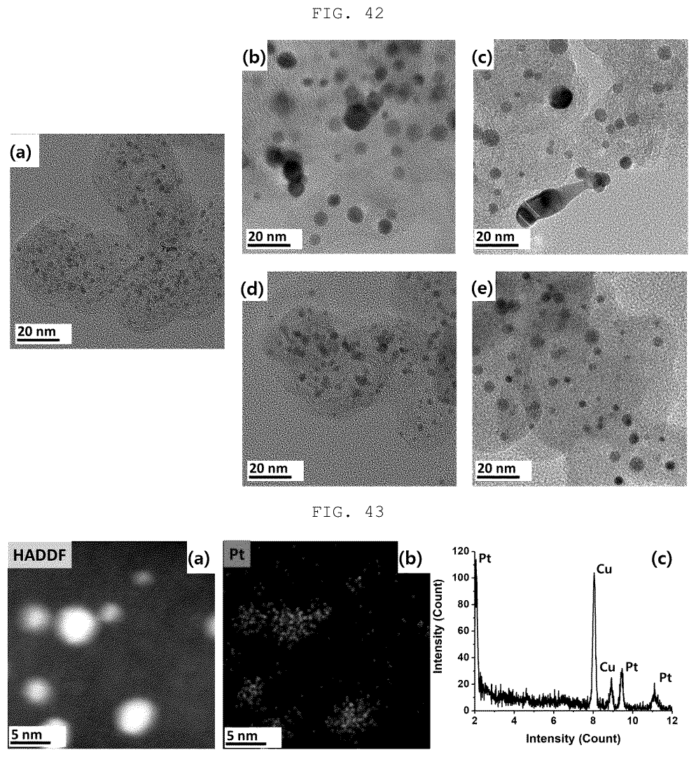

FIG. 40 is a drawing showing Pt 4f X-ray photoelectron spectroscopy (XPS) spectra, measured before and after performing ADT for cathode catalyst layers included in membrane electrode assemblies manufactured in Comparative Example 5 and Example 5. In the Pt 4f XPS spectrum, the peak was deconvoluted into two peaks corresponding to Pt⁰ and Pt²⁺. For example, in Pt 4f_{7/2}, Pt⁰ had ˜71.9 eV, and Pt²⁺ had ˜72.9 eV. Referring to FIG. 40, in Comparative Example 5, as the ADT cycle increased, a tendency in which the peak intensity of Pt²⁺ was gradually decreased, but the peak intensity of Pt⁰ was gradually increased was shown. This is considered to be due to the fact that the size of the platinum (Pt) metal particles increased to decrease the surface of platinum (Pt) and greatly loss catalytic activity. Example 5 showed the same tendency in which the peak intensities of Pt²⁺ and Pt⁰ were decreased/increased according to the increase in the ADT cycle, like Comparative Example 5, but the decrease or increase change rate was significantly small, unlike Comparative Example 5. Specifically, in Comparative Example 5, a ratio (I₂/I₁) between the Pt(II) peak intensity (I₂) after the accelerated durability test of 90,000 cycles and the Pt(II) peak intensity (I₁) before the accelerated durability test was calculated as 0.41, and in Example 5, the ratio (I₂/I₁) of the peak intensities described above was calculated as 0.71, and thus, it was confirmed that the decrease change rate of the Pt²⁺ peak intensity of Example 5 was lower than that of Comparative Example 5.

In FIG. 41, (a) is a drawing showing XRD patterns depending on ADT cycles of a gas diffusion layer included in the membrane electrode assembly manufactured in Example 5, and (b) is a drawing showing Ag 3d XPS spectra.

Referring to FIG. 41, silver (Ag) particles included in the gas diffusion layer were greatly decreased after 30,000 (30 k) cycles, and mostly disappeared after 90,000 (90 k) cycles. Specifically, referring to (b) of FIG. 41, the peak intensity of Ag 3d_{5/2} was 15.0% of the initial peak intensity after 30,000 (30 k) cycles and completely disappeared after 90,000 (90 k) cycles. In order to confirm a more correct decreased amount of silver (Ag), ICP-OES analysis was additionally performed. As a result, the amount of silver (Ag) was shown to be 0.13 mg/cm² which was 13% of the initial loading amount (1 mg/cm²) after 30,000 (30 k) cycles, and the signal was not detected after 90,000 (90 k) cycles. Thus, it was found that metallic silver (Ag) included in the gas diffusion layer was oxidized to Ag⁺ and etched in the electrolyte solution, but active metal platinum (Pt) remained as metallic Pt due to the sacrifice of silver (Ag) during the ADT cycles.

In FIG. 42, (a) is a transmission electron microscope (TEM, Tecnai G2 twin) image of the catalyst layer included in the Comparative Example 5 or Example 5 before performing ADT, (b) and (c) are TEM images of the catalyst layer included in the Comparative Example 5 after 30,000 (30 k) and 90,000 (90 k) cycles, respectively, and (d) and (e) are drawings showing TEM images of the catalyst layer included in Example 5 after 30,000 (30 k) and 90,000 (90 k) cycles, respectively. Referring to (a) of FIG. 42, platinum (Pt) particles had a size of 2 to 3 nm before performing ADT and had a uniform size distribution, and the average particle diameter at this time was 2.5 nm. Referring to (b) and (c) of FIG. 42, the size of platinum (Pt) particles was greatly increased to 5 to 50 nm, and at this time, the average particle diameter after 30,000 (30 k) cycles and 90,000 (90 k) cycles was 10 nm and 15 nm, respectively. The increase in the platinum (Pt) particle size was due to the dissolution and aggregation of platinum (Pt), and this became a main cause of degradation of performance of the fuel cell. However, referring to (d) and (e) of FIG. 42 regarding Example 5, the size and the size distribution of platinum (Pt) particles were changed much less than Comparative Example 5, even after performing ADT, and at this time, the average particle diameter after 30,000 (30 k) cycles and 90,000 (90 k) cycles was ˜3 nm and ˜4.5 nm, respectively. The reason for the results is that since the silver (Ag) particles were included in the gas diffusion layer, the active metal particles in the catalyst layer were prevented from being oxidized and aggregated.

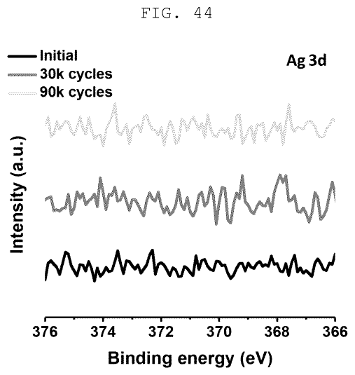

FIG. 43 is drawings showing a high angle annular dark field scanning transmission electron microscopy (HAADF-STEM, FEI Themis Z) image of a catalyst layer included in Example 5 after 90,000 (90 k) cycles, and corresponding EDS mapping image and EDS spectrum. FIG. 44 is a drawing showing Ag 3d XPS spectra depending on ADT cycles of the catalyst layer of Example 5.

Referring to FIGS. 43 and 44, it was found that silver (Ag) ions which were formed by oxidation during ADT were deposited on the active metal particles included in the catalyst layer or did not form an alloy, and silver (Ag) was not observed on the catalyst layer after performing ADT.

Since the composite according to the present invention includes active metal particles and sacrificial metal particles which are independently supported on a carbon support, degradation of the active metals may be suppressed, thereby having significantly improved durability while maintaining excellent activity of a catalyst.

Since the membrane electrode assembly according to the present invention has active metal particles placed on a carbon support and sacrificial metal particles placed on a support for a gas diffusion layer, it may have excellent catalytic activity and significantly improved durability for the same reason as the composite described above.

Since the fuel cell according to the present invention includes the composite and/or the membrane electrode assembly described above, it may have high charge and discharge durability and a long lifespan.

The method for manufacturing a composite and the method for manufacturing a membrane electrode assembly according to the present invention may greatly improve catalytic activity and durability in an electrode for a fuel cell by a simple process.

Hereinabove, although the present disclosure has been described by the specific matters and limited exemplary embodiments in the present specification, they have been provided only for assisting the entire understanding of the present disclosure, and the present disclosure is not limited to the exemplary embodiments, and various modifications and changes may be made by those skilled in the art to which the present disclosure pertains from the description.

Therefore, the spirit described in the present specification should not be limited to the above-described exemplary embodiments, and the following claims as well as all modifications made equally or equivalently to the claims are intended to fall within the scope and spirit of the specification.

What is claimed is:

1. A composite comprising: a carbon support; active metal particles; and sacrificial metal particles which are oxidized or reduced instead of the active metal particles,
wherein the active metal particles and the sacrificial metal particles are independently supported on the carbon support.

2. The composite of claim 1, wherein the active metal particles and the sacrificial metal particles do not form an alloy with each other.

3. The composite of claim 1, wherein the active metal particles include one or more metals selected from the group consisting of palladium (Pd); platinum (Pt); gold (Au); ruthenium (Ru); rhodium (Rh); iridium (Ir); osmium (Os); and alloys including the metals.

4. The composite of claim 1, wherein a metal included in the sacrificial metal particles has a lower standard reduction potential than a metal included in the active metal particles.

5. The composite of claim 1, wherein the sacrificial metal particles include one or more metals selected from the group consisting of silver (Ag); palladium (Pd); iridium (Ir); ruthenium (Ru); rhodium (Rh); platinum (Pt); osmium (Os); iron (Fe); aluminum (Al); and alloys including the metals.

6. The composite of claim 1, wherein a ratio (D₂/D₁) between an average particle diameter (D₂) of the active metal particles after an accelerated durability test of 30,000 cycles of the composite and an average particle diameter (D₁) of the active metal particles before the accelerated durability test is 3 or less.

7. The composite of claim 1, wherein an atomic ratio between a sacrificial metal included in the sacrificial metal particles and an active metal included in the active metal particles is 1:0.1 to 1:50.

8. The composite of claim 1,
wherein the active metal included in the active metal particles includes platinum (Pt), and
a difference in 2θ values of maximum peaks shown in a range of 2θ=39.8±1.0° in X-ray diffraction (XRD) spectra of the composite and pure platinum (Pt) is 0.3° or less.

9. The composite of claim 1,
wherein the active metal included in the active metal particles includes platinum (Pt), and
a ratio (I₀/I_{II}) between a Pt (0) peak intensity (I₀) and a Pt(II) peak intensity (In) in a Pt 4f_{7/2} XPS spectrum by X-ray photoelectron spectroscopy (XPS) is 1.8 or more.

10. A method for manufacturing a composite, the method comprising:
mixing a dispersion including a carbon support on which active metal particles are supported and a solution including a sacrificial metal precursor to prepare a first reaction solution; and
adding a reducing agent to the first reaction solution to synthesize a composite in which the active metal particles and sacrificial metal particles are independently supported on the carbon support.

11. A method for manufacturing a composite, the method comprising:
mixing a dispersion including a carbon support on which active metal particles are supported and a dispersion including a carbon support on which sacrificial metal particles are supported to prepare a second reaction solution; and
adding a reducing agent to the second reaction solution to synthesize a composite in which the active metal particles and the sacrificial metal particles are independently supported on the carbon support.

12. A membrane electrode assembly comprising: a cathode including a first catalyst layer and a first gas diffusion layer; an anode including a second catalyst layer and a second gas diffusion layer; and a polymer electrolyte membrane disposed between the cathode and the anode,
wherein the first catalyst layer includes active metal particles, and
the first gas diffusion layer includes a support for the first gas diffusion layer; and sacrificial metal particles which are supported on the support for the first gas diffusion layer and are oxidized or reduced instead of the active metal particles.

13. The membrane electrode assembly of claim 12, wherein one surface of the support for the first gas diffusion layer on which the sacrificial metal particles are placed faces one surface of the first catalyst layer.

14. The membrane electrode assembly of claim 12,
wherein the second catalyst layer includes the active metal particles, and
the second gas diffusion layer includes a support for the second gas diffusion layer and the sacrificial metal particles which are supported on the support for the second gas diffusion layer and are oxidized or reduced instead of the active metal particles.

15. The membrane electrode assembly of claim 12, wherein the active metal particles include one or more metals selected from the group consisting of palladium (Pd); platinum (Pt); gold (Au); ruthenium (Ru); rhodium (Rh); iridium (Ir); osmium (Os); and alloys including the metals.

16. The membrane electrode assembly of claim 12, wherein a metal included in the sacrificial metal particles has a lower standard reduction potential than a metal included in the active metal particles.

17. The membrane electrode assembly of claim 12, wherein the sacrificial metal particles include one or more metals selected from the group consisting of silver (Ag); palladium (Pd); iridium (Ir); ruthenium (Ru); rhodium (Rh); platinum (Pt); osmium (Os); iron (Fe); aluminum (Al); and alloys including the metals.

18. The membrane electrode assembly of claim 12, wherein a ratio (D₂/D₁) between an average particle diameter (D₂) of the active metal particles after an accelerated durability test of 30,000 cycles and an average particle diameter (D₁) of the active metal particles before the accelerated durability test is 3 or less.

19. The membrane electrode assembly of claim 12, wherein an atomic ratio between a sacrificial metal included in the sacrificial metal particles included in the first gas diffusion layer and an active metal included in the active metal particles included in the first catalyst layer is 0.1:1 to 100:1.

20. The membrane electrode assembly of claim 12,
wherein the active metal included in the active metal particles includes platinum (Pt), and
the first catalyst layer has a ratio (I₂/I₁) between a Pt(II) peak intensity (I₂) after an accelerated durability test of 90,000 cycles and a Pt(II) peak intensity (I₁) before the accelerated durability test in a Pt 4f XPS spectrum by X-ray photoelectron spectroscopy (XPS) of 0.5 or more.

21. The membrane electrode assembly of claim 12, wherein a content of the sacrificial metal particles per unit area of the support for the first gas diffusion layer is 0.1 to 100 mg/cm².

22. A method for manufacturing a membrane electrode assembly, the method comprising:
1) doping a sacrificial metal precursor on a support for a first gas diffusion layer;
2) reducing the sacrificial metal precursor doped on the support for a first gas diffusion layer to prepare a first gas diffusion layer in which sacrificial metal particles are supported on the support for a first gas diffusion layer;
3) forming a first catalyst layer on one surface of a polymer electrolyte membrane;
4) forming a second catalyst layer on the other surface of the polymer electrolyte membrane;
5) forming the first gas diffusion layer on the first catalyst layer; and
6) forming a second gas diffusion layer on the second catalyst layer.

23. An electrode for a fuel cell comprising the composite of claim 1.

24. A fuel cell comprising: the membrane electrode assembly of claim 12; or an electrode comprising a composite comprising: a carbon support; active metal particles; and sacrificial metal particles which are oxidized or reduced instead of the active metal particles, wherein the active metal particles and the sacrificial metal particles are independently supported on the carbon support.
